(19) United States
(12) Patent Application Publication
(10) Pub. No.: US 2002/0049049 A1
(43) Pub. Date: Apr. 25, 2002

(54) System for delivering wireless information services to messaging devices

(76) Inventors: Joel E. Sandahl, Southlake, TX (US); Ransom W. Stephens, Mansfield, TX (US); Thomas F. Mezger, Southlake, TX (US)

Correspondence Address: Kenneth J. Lukacher, South Winton Court, 3136 Winton Road South, Suite 204, Rochester, NY, 14623, US

(21) Appl. No.: 09/957,855

(22) Filed: Sep. 21, 2001

Related U.S. Application Data
(60) Provisional application No. 60/234,704, filed on Sep. 22, 2000.

(51) Int. Cl. H04M 11/10; H04M 3/42

(52) U.S. Cl. 455/414; 455/412

(57) ABSTRACT

A system for delivering information services is provided having a service provider capable of sending directory messages and information service messages to wireless messaging devices through one or more regional transmission systems. The directory messages define a directory of information service which may be organized in categories and subcategories. In response to receiving directory messages, each messaging device builds or updates a directory profile in its memory. The service provider sends information service messages to messaging devices for information services under the directory. The directory and information services messages are sent on the same radio signaling address, and each messaging device is programmed to receive directory and information service messages on that radio signaling address. The user of each messaging device can enable or disable different information services at the device without interaction with the service provider. Information service messages when received for information services enabled by the user of each messaging device are stored in memory of the device for retrieval by the user on the device's display. Information service messages may be sent in different geographic regions in which the user of each messaging device may further enable or disable reception of information service messages at the device based on the device's home region and/or roam (non-home region) reception. Advertising may be included with stored information service messages when retrieved by the user. Further, the user of each messaging device may manually enter information services independent of directory messages in the stored directory profile of the device to enable reception of such information services at the device.

### DESCRIPTION

This application claims the benefit of priority to U.S. Provisional Patent Application No. 60/234,704, which is herein incorporated by reference.

### FIELD OF THE INVENTION

This invention relates to a system (and method) for delivering wireless information services, and relates particularly to, a system for delivering wireless information services to wireless messaging devices, such as radio pagers, wireless telephones, personal data assistants, and other types of wireless capable computers in a directory of information services which may be enabled or disable as desired at the messaging devices by their users. The invention is useful for enabling wireless messaging devices to receive a directory of information services from an information service provider, such that the messaging devices each operate independent of the service provider in the selection by users of which information services are provided to users.

### BACKGROUND OF THE INVENTION

Over the last several years, wireless messaging has grown from sending simple numeric messages to pagers to sending detailed messages to a variety of different wireless messaging devices, such as alphanumeric pagers, wireless telephones, personal data assistants, and other types of wireless capable computers. Wireless information services involve the sending of information in a message to such wireless messaging devices. Typically, an information service provides message content to messaging providers who encode and transmit the messages. The messages are broadcast to groups of users and generally are of two types: information services with broad appeal such as weather reports, traffic reports, and late breaking news, and information services that are easily tailored to personal interests like periodic stock quotes, horoscopes, and sports scores of specific teams.

Information service messages are transmitted and decoded the same as any other wireless message received by a wireless messaging device. Messages are encoded by the provider in a standard protocol and then transmitted through modulated radio frequency signals across a geographic region. Typical protocols used, for example, are POCSAG, ERMES, GOLAY, APOC, and FLEX. Each message is addressed to a single or set of messaging devices. The addressing scheme employs radio signaling addresses commonly called “capcodes.” Each message is transmitted to a signaling address and each messaging device is programmed to decode messages addressed to a small list of radio signaling addresses. In other words, when a message is transmitted, every messaging device decodes it to the extent that the radio signaling address is revealed. If the signaling address is identical to one of the radio signaling addresses in the device's list, then the device completely decodes the message, alerts the user, and displays the message. Thus each messaging device is usually programmed with at least one unique radio signaling address for reception of messages directed to that, and only that device, and perhaps several others that may be common to a group of messaging devices. For example, a weather update transmitted by a system will be addressed to one radio signaling address. Every user who wishes to receive the weather update must have a messaging device that includes this signaling address in its internal list, otherwise the device will not decode the message. This example demonstrates “one to many” message transmission where one transmitted message is received on many messaging devices.

The capcode radio signaling addressing scheme evolved from the paging industry in an environment where messaging devices rarely needed more than one radio signaling address. Most alphanumeric pagers can decode messages addressed to only a few capcodes. The address space in a messaging device is typically limited to a small number of radio signaling addresses to reduce the cost of the messaging device. For instance, if a device has two radio signaling addresses, then it must be capable of decoding two messages simultaneously. As the number of radio signaling addresses increase, the amount of messaging device processing power and memory storage must also increase, increasing the cost of the messaging device. The total number of possible addresses is fixed, and of this total number, typical messaging devices can be programmed to decode messages transmitted to only a few. As a result, the number of information services to which a user may subscribe is limited, which is a problem with the growing use of wireless messaging devices to receive different types of messages by different groups of users.

Conventionally in the delivery of information services to messaging devices, every specific information service corresponds to a specific radio signaling address, and for a device to decode messages from that service, it must include that radio signaling address in its decoding list. Modification of the list of services or, equivalently, radio signaling addresses, currently requires the user to contact the service provider and request that a service be enabled. In a one-way messaging device, capable of only receiving messages, this may be achieved by the user of the device contacting the provider, such as by telephone. The provider may then send an Over The Air Programming (OTAP) message to the messaging device that adds the appropriate radio signaling address to the device's internally stored list. The device is then programmed to decode and display the information messages of the desired service received at that radio signaling address.

In a two-way messaging device, capable of both receiving and transmitting messages, the device can be used to send a message to the service provider for the requested service, such as in the selective call device of U.S. Pat. No. 5,926,104. In this patent, the selective call device uses its available radio signaling address ports (referred to as subaddress ports in the patent) to receive messages. The selective call device receives and decodes a directory of information services in which each information service has an associated radio signaling address at which the service can be received by the device for a duration, such as a time period or a set number of messages. The device enables the user to select the information service from the directory, and a transmitter of the device sends the selected information service to the service provider. If the user is authorized, the service provider sends a confirmation message to the selective call device to enable the device to receive the information service at the assigned radio signaling address.

U.S. Pat. No. 6,249,688 describes a directory structure in a radio pager not for the selection of information services, but for storage of messages in hierarchical folders of different types of information in accordance with decoded addresses received by the radio pager. Although the user can prioritize notification to the user based on a folder associated with the information message, the user does not have the capability at the pager to enable or disable the information services received by the pager independent of the provider of the information services.

In addition to wireless messaging devices such as pagers, other devices may also be capable of receiving messages from radio frequency transmissions, such as small, hand-held, battery powered computers, e.g., Personal Data Assistants/Palm devices, laptop/notebook computers, wireless telephone, that increasingly include the capabilities of one-way or two-way wireless messaging devices. However, regardless of the type of device receiving information service messages, each different information service message is addressed to messaging devices through a different radio signaling address, e.g., capcode, and each device must be assigned a different radio signaling address for every type of information service to which a user of the device has subscribed. As a result, due to the limited number of radio signaling addresses available which a messaging device can receive, each messaging device is thereby limited to the number of information services a messaging device is capable of receiving. Typically, low cost messaging devices have four or fewer radio signaling addresses, and, as stated earlier, the cost of the messaging device increases with the increasing number of radio signaling addresses. Accordingly, it would be desirable to provide messaging devices which can receive information services that are not limited by the radio signaling addresses available, or limited by the number of radio signaling addresses a messaging device can be assigned to receive information services.

Conventional information service message delivery, particularly to one-way alphanumeric pagers that cannot support the service message delivery described in U.S. Pat. No. 5,926,104, in many instances involves a user subscribing to a service on an information provider's web-page independent of the actual provider of the paging service for the pager. Typically to start such service message delivery for a one-way pager, the user of the pager provides the pager access telephone number to the information service and the information service sends the information as alphanumeric pages to the pager. This often causes the transmission of the same message to a large number of separate radio signaling addresses associated with the different pagers, a very inefficient use of the messaging infrastructure bandwidth. It would thus be desirable to provide a method of delivery of information service which eliminates the need for redundant message transmissions to different messaging devices.

Another problem with the conventional delivery of information services is that to change which information messages are received and decoded, the user is required to interact directly with the service provider. Thus, the service provider must maintain extensive databases of the profiles of the services that each subscriber receives. Therefore, it would further be desirable to provide a messaging device with the ability to maintain its own profile of services and enables the user of the device to independently select which of the information services are to be provided to the user.

Although two-way messaging devices facilitate the ability of a user to send transmissions in feedback messages to the service provider to enable reception of an information service, such as in earlier described U.S. Pat. No. 5,926,104, two-way devices are expensive and larger compared to typically one-way messaging devices as they require transmitter circuitry. Moreover, the additional infrastructure of a network of receivers in a region is required for enabling two-way messaging. Such a network of receivers is expensive as the receivers must be capable of receiving the very low power messages of two-way messaging devices in each geographic region where two-way messaging is provided. Further, additional equipment is needed by the service provider for processing messages from two-way messaging devices. Although two-way messaging devices provide the benefit of enabling users to select information services being provided, they are dependent on interaction with service provider by reliance on feedback messages to enable each service's delivery. Accordingly, it would be further desirable to provide a one-way messaging device which emulates the two-way device's ability to enable user to select which information service sent to the messaging device is being provided to the user independent of the service provider.

### SUMMARY OF THE INVENTION

Accordingly, the principal object of the present invention is to provide a system for delivering information services from a service provider to messaging devices in which the user at each messaging device can select in a directory which of such information services are enabled or disabled at the device independent of the service provider, without contacting or otherwise engaging the service provider as in prior art delivery of information services, and only information service messages received from information services enabled by the user at the device are provided by the device to the user.

Another object of the present invention is to provide a system for delivering information services from a service provider to messaging devices in which each messaging device in response to directory messages received from the service provider updates a persistent directory profile of information services, in its memory, that can be organized into categories and subcategories.

A still further object of the present invention is to provide a system for delivery of information services in which the user, via a user interface, can modify a directory profile in memory of the device to enable or disable full decoding of information services received by the device.

A further object of the present invention is to provide a system for delivering information services from a service provider to messaging devices in which directory messages defining a directory of information services may be sent by the service provider to the messaging devices at a radio signaling address, and messages for multiple information services can be sent by the service provider to messaging devices at the same radio signaling address.

Yet another object of the present invention is to provide a system for delivering information services to messaging devices in which when such device are one-way messaging devices, they emulate the capability of a two-way messaging device of the prior art in selecting information service to be provided to the user of the device.

A still further object of the present invention is to provide a system for delivering information services to messaging devices in which the number of information services capable of being delivered is not limited by the number of radio signaling addresses available in messaging devices.

A further object of the present invention is to provide a system for delivering information services to messaging devices enabling the user of a messaging device to manually enter information services which were not provided, and independent of, a directory of information services received by the messaging device from a service provider.

Another object of the present invention is to provide a system for delivering information services to messaging devices with optional roaming reception capability where unique directories of information services can be delivered to messaging devices in different geographical regions, in which the user of each messaging device can select, independent of a service provider, through interaction with the messaging device user interface, whether or not to receive messages of an information service when away from their home region as well as when they are in their home region.

Yet another object of the present invention is to provide a system for storing information on the messaging devices associated with one or more information services so that this information can be attached to the messages for such services when they are received and stored for retrieval by users of the devices.

Briefly described, the present invention embodies a system for delivering information services to messaging devices, such as pagers, handheld computers, personal data assistants, wireless telephones, notebook computers or other wireless devices capable of receiving wireless messaging signals, where the messaging devices receive encoded messages through radio signals from one or more transmission systems and are programmed to receive and decode messages having a radio signaling address. Information services may be for example, short message services, wireless Internet broadcast services, and public/private group message services. The system includes an information service provider which sends directory messages to the messaging devices, via the transmission systems, in accordance with a directory of information services that can be organized into categories and subcategories, and sends information service messages to messaging devices having information content associated with information services. Each messaging device of the system in response to receiving directory messages builds or updates a directory profile in the memory of the device defining a directory of categories, subcategories, and information services which may be under categories or subcategories. Optionally, one or more devices may be provided with a directory of information service without subcategories, or without categories and subcategories. Each messaging device enables the user of the messaging device, via the device's user interface, to select which of the information services of the directory profile are enabled or disabled, to select how the messaging device alerts the user upon reception of an enabled information service message, and to select the folder where the messages should be temporarily stored in memory of the device. The messaging device updates the directory profile in accordance with such user selections. Only the information content of received information service messages associated with one of the enabled information services are decoded by each messaging device and stored in memory of the device for retrieval and display to the user of the device.

The directory and information service messages are encoded by the service provider with a radio signaling address in accordance with data structures which the messaging devices are programmed to decode to identify directory and information service messages in the system. Messaging devices intended to receive the messages from the service provider have this radio signaling address programmed in their device's internal list of radio signaling addresses. Preferably, the directory and information service messages are each sent using the same radio signaling address, called herein the primary signaling address, programmed in the device's internal list of signaling addresses which the device will receive. However, a signature flag in the message may identify the message as being from the system if a message from the service provider is received with a radio signaling address in the device's internal list of signaling addresses other than the primary signaling address. Other data fields include a flag to identify the message as being a directory message or an information service message.

In addition to information services associated with directory messages, each messaging device is also capable of enabling the user of the messaging device to manually add, for example via key sequences on the device, information services not provided to the directory profile of services by directory messages. These manually entered information services are referred to herein as independent information services, in contrast with information services associated with directory messages. The service provider may send these information service messages for such independent information services, and the user may select at their device to enable or disable reception of independent information services. Independent information service messages may utilize the same primary signaling address as directory messages and other information service messages.

Optionally, the system may enable roaming by including transmission region information (i.e., the transmission region from which a message was broadcast) in directory messages and only directory messages from the user's home region, i.e., the region that the user has registered as home region with the service provider, are stored in the directory profile of information services. The information service messages may also include transmission region information to identify the messages from the home region. Each messaging device provides three options to its user for the process of enabling an information service for reception: home, roam, or both home and roam. A home message is one transmitted from the user's home region and a roam message is one transmitted from a region other than the user's home region. Only the information content of received information service messages associated with one of the enabled information services and from either or both of the home region, if home messages are enabled, and regions other than the home region, if roam messages are enabled, are fully decoded by each messaging device and stored in memory of the device for display to the user of the device.

Further, messages in the system may be distinguished from directory message or information message from other information service networks by including an information system network identifier in each message sent to messaging devices. The messaging devices are programmed by the service provider with the network identifier and all messages with that identifier are processed.

The messaging devices convert the directory composed of one or more directory messages into the directory profile according to a data structure composed of information services that can be organized into a hierarchical system of categories and subcategories. The directory profile maintains this data structure in accordance with information service addresses and category information provided by the directory messages. The information service addresses serve as subaddresses beneath the radio signaling address. The directory profile is updated when a new directory message is received, in which enabled information services in the previous directory profile in common with the updated directory profile are maintained, and new information services are notified to the user when the directory is displayed by the user at the device in accordance with the stored directory profile.

The messaging devices may receive normal page messages as well as information service messages on any of the radio signaling addresses stored in internal memory of the device; though all information service and directory messages can be transmitted to the same single radio signaling address.

Each messaging device has a user interface with keys and a display enabling the user of the device to display the directory profile of information services and to enable the user to select one or more of the information services to be enabled (roam and/or home enabled) or disabled. The user interface also allows the user to enter alphanumeric characters providing the information service addresses of independent information services and allowing these services too to be enabled or disabled. Other methods for providing the information service addresses of independent information services may also be employed such as through interaction with a provider, for example on a web page with the independent service title loaded on the device through an Over The Air Programming (OTAP) message transmitted by the provider, or by the user entering the independent information service address on a PC and then loading it onto the messaging device through an interface such as an infrared port or data bus. The directory profile in memory of the messaging device associates a set of status flags with the information service addresses that indicate whether the service is new, enabled (roam and/or home enabled) or disabled. Memory of the messaging device also associates a set of flags with any category or subcategory information used to organize the services that indicate whether or not a service associated with the category or subcategory is enabled. The set of flags associated with a service is modified, in response to the user, via the user interface: when a service is enabled the appropriate flag is set; when a service is disabled the flag is cleared. Included in the first few data fields of each information service message are data indicating that it is an information service message, its information service address, and other useful data such as its associated information service network and the region from which it was transmitted. The information content is retained and stored when the radio signaling address is included on the device internal list of radio signaling addresses, and the information service address is recognized as one of those included in the directory profile and the service is enabled for reception. If the roaming option is implemented, then the identity of the region from which it was transmitted is included in the first few data fields of the message and the latter requirement for service message retention is provided by: the region of transmission is recognized as the device's home region and the home enabled flag associated with the information service address is enabled, or the region of transmission is not recognized and the roam enabled flag associated with the information service address is enabled, or both. Through the device display mechanism of the device's user interface, the information service list may also indicate information services that are enabled (optionally, home or roam enabled or both), such as by the presence of one or more icons, or accompanying indicative text, or different modes of title display such as reverse video, or a nonstandard font, when information services of the directory are displayed to the user.

The system further embodies a method including the steps of: programming messaging devices to receive messages having a radio signaling address; sending directory messages encoded with one of the device's internally recognized radio signaling addresses to the messaging devices having a directory profile of information services that may be organized in zero or more categories and zero or more subcategories; sending to the messaging devices information service messages encoded with one or more radio signaling addresses common to messaging devices on the information service network having information content associated with the information services; receiving and decoding at the messaging devices the directory messages in accordance with information provided in the first few data fields of the message indicating that it is a directory message; modifying the directory profile of information services in memory of the messaging devices according to the directory message; selecting at each messaging device by the user of the messaging device which of the information services of the directory are enabled (optionally, home and/or roam enabled) and disabled; entry of additional information service addresses by the user of the messaging device and their enable/disable status; receiving information service messages at each of the messaging devices in accordance with information provided in the first few data fields of the message indicating that it is a service message and, optionally, its region of origin; decoding the information content of the received information service message at each messaging device only when the information service associated with the information service message at each of the messaging devices is one of the appropriately enabled information services; selecting at each messaging device by the user of the messaging device how the device should alert the user upon reception of an information service message and how the message should be temporarily stored; and displaying to the user of the messaging device the decoded information content of the information service messages.

### BRIEF DESCRIPTION OF THE DRAWINGS

The foregoing objects, features and advantages of the invention will become more apparent from a reading of the following description in connection with the accompanying drawings, in which:

FIG. 1 is a block diagram of the system in accordance with the present invention;

FIG. 2 is a diagram of one example of a directory organization defining information services in the system of FIG. 1 having multiple categories of information services without subcategories;

FIG. 2A is diagram of another example of a directory organization used in defining information services in the system of FIG. 1 showing categories, subcategories, and information services in the directory;

FIG. 2B is diagram of another example of a directory organization used in defining information services in the system of FIG. 1 showing information services without categories or subcategories;

FIG. 3 is a block diagram of the system of FIG. 1 showing the construction, encoding, and transmission of directory messages by a service provider to messaging devices;

FIGS. 3A, 3B, 3C, and 3D show the structure of four types of directory messages which may be sent by the service provider to messaging devices in the system of FIG. 1;

FIG. 4 is a block diagram of an example of the messaging devices in the system of FIG. 1 representing a one-way alphanumeric wireless paging unit;

FIG. 5 is a high level flow chart of the process in the system of FIG. 1 for delivery of information services from the service provider to messaging devices;

FIGS. 6A, 6B, 6C and 6D are diagrams showing the different components of the linked list of a directory profile for each messaging device of the system of FIG. 1 defining the directory of information services, where FIG. 6A shows the first level of the directory profile, and FIGS. 6B-6D represent the structure of three different types of elements of the linked list for storing categories/subcategories, information services, and independent information services, respectively;

FIG. 7A is a block diagram of the process in each of the messaging devices of the system of FIG. 1 for receiving directory messages from the service provider;

FIG. 7B is a flow chart showing the processing by the define service processor of FIG. 7A in response to a messaging device receiving a define service directory message;

FIG. 7C is a flow chart showing the processing by the remove service processor of FIG. 7A in response to a messaging device receiving a remove service directory message;

FIG. 7D is a flow chart showing the processing by the define category processor of FIG. 7A in response to a messaging device receiving a define category directory message;

FIG. 7E is a flow chart showing the processing by the remove category processor of FIG. 7A in response to a messaging device receiving a remove category directory message;

FIGS. 7F and 7G are connected flow charts showing the processing by the directory message post processor of FIG. 7A;

FIG. 8 is an example of a multi-level directory organization of a directory profile stored in a messaging device in the system of FIG. 1;

FIGS. 8A and 8B is an example of data structure in memory of a messaging device for storing the directory profile in accordance with the directory organization of FIG. 8.

FIG. 9 is a diagram of the user interface and display of a messaging device in the example of FIG. 4 for an alphanumeric wireless paging unit;

FIGS. 9A-9G are examples of display screens on the user interface of the messaging device of FIG. 9;

FIGS. 10A and 10B are connected flow charts of the process enabling a user of the messaging device of FIG. 1 to enable or disable decoding of information services with the user interface of FIG. 8 and thereby modify the information services received and decoded without contacting the service provider;

FIG. 11 is a flow chart showing the process in the messaging devices to add (or modify) an independent information service in the directory profile of the messaging device;

FIG. 12 is diagram of the software modules in the messaging device of FIG. 4 for providing an interactive command interpreter in response to key sequence and cursor position of the user interface of FIG. 9;

FIG. 13A is a block diagram of the process for acquisition, assembly, and encoding of information service messages in the system of FIG. 1.

FIG. 13B is an example of the structure of an information message in the system of FIG. 1 associated with directory messages;

FIG. 13C is an example of the structure of an information message in the system for independent information service messages;

FIGS. 14A and 14B are connected flow charts of the process in the messaging devices of the system of FIG. 1 for receiving and decoding information service messages;

FIG. 15 is a flow chart showing the process of message retrieval at messaging devices in the system of FIG. 1;

FIG. 16A is a block diagram showing the generation and transmission of directory messages to messaging devices in the system of FIG. 1;

FIG. 16B is an example of the structure of an information message in the system of FIG. 1 compatible with information service delivery of the prior art; and

FIG. 16C is a block diagram showing the sending of information service messages in the system of FIG. 1 compatible with information service delivery of the prior art.

### DETAILED DESCRIPTION OF THE INVENTION

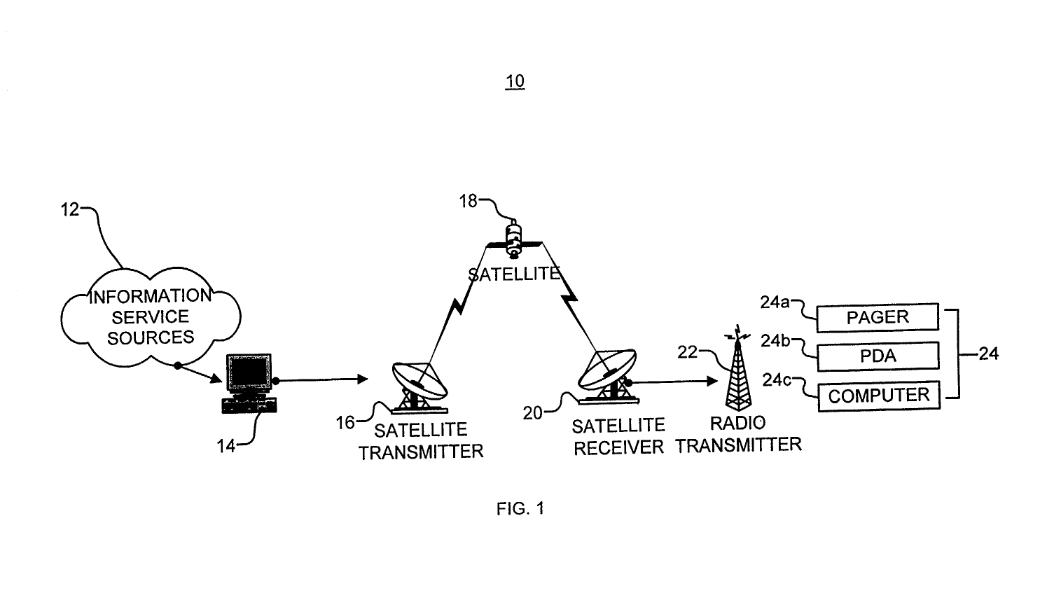

Referring to FIG. 1, a system 10 is shown for delivering to messaging devices 24 a directory of information services, and delivery of messages for such information services enabled by users at their respective messaging devices. For the purposes of illustrating the invention, the messaging devices 24 are described below as one-way alphanumeric paging devices, i.e., a paging device capable of receiving but not sending messaging signals. Such one-way alphanumeric paging devices present an implementation of the invention with limited processing power and a limited user interface. Accordingly, other more advanced programmable devices, capable of at least receiving messaging signals, may similarly provide the messaging devices of the invention, such as hand-held computers, personal data assistants, notebook computers, and two-way paging devices. As will be described, the system 10 may optionally provide for receipt of messages during roaming of messaging devices 24, use of multiple radio signaling addresses for different directories, unique advertising content for different information services, and information services which are manually entered by users at their messaging devices.

System 10 includes an information service provider 14 which provides two types of messages to messaging devices 24, directory messages and information service messages, in accordance with the present invention. The information service provider 14 represents a computer-based system, such as a computer server, capable of receiving information electronically from information (content) sources or providers 12 and sending encoded messages to messaging devices 24 via one or more transmission systems. The transmission systems may be typical short message transmission systems, and in general, they can represent any wireless networking or messaging system that can support one-to-many data transmissions, covering geographic regions. The transmission systems are represented in FIG. 1 by an uplink satellite transmitter 16, satellite 18, downlink receiver 20, and radio transmitter 22. Examples of a non-centrally and centrally controlled transmission systems are described in U.S. Pat. No. 6,097,944, issued Aug. 1, 2000, which is herein incorporated by reference. Although a satellite link system is shown in FIG. 1, any other broadcast link system may also be used, for example, non-satellite earth-based transmission systems. To deliver information services, the messaging provider 14 composes information service messages as text messages, but in general the messages could be composed of graphics in addition to, or instead of, text, from one or more different content sources 12 including, for example, the Internet, or other electronic media sources capable of sending information designated in one or more topics. Along with a radio signaling address, the messages are encoded by the transmission system into digital data packets according to a wireless networking or messaging protocol, preferably the FLEX paging protocol of the Motorola Corporation, Inc. However, other messaging protocols could be used. The message is transmitted at modulated radio frequency (RF) signals by radio transmitters 22 to messaging devices 24. Messaging devices 24 in the coverage area of geographic regions of transmission systems can receive messages from radio transmitter 22, decode the radio signaling address and process each message as described herein, if the address of the message matches a radio signaling address included in an internally stored list of radio signaling addresses on the messaging device.

Each messaging device 24 represents a programmable device having a microprocessor or controller and memory storing a directory profile of information services that can be organized into categories and subcategories. The directory profile is built and updated in response to directory messages from service provider 14 sent to messaging devices 24 over the transmission systems. As stated earlier, the messaging devices 24 is described herein as alphanumeric pagers 24a, but generally could be any wireless device, such as personal data assistants (PDA) 24b, and computers 24c, having the capability of receiving and decoding messages in system 10.

For each directory, the directory messages and information service messages may each be encoded on one common radio signaling address referred herein as the primary signaling address (PSA), e.g., in the paging environment radio signaling addresses are commonly called capcodes.

A messaging device may subscribe to one or more different directories in which each one is transmitted at a different PSA. The PSA of each directory is stored in each messaging device 24 in the internal list of radio signaling addresses on the messaging device.

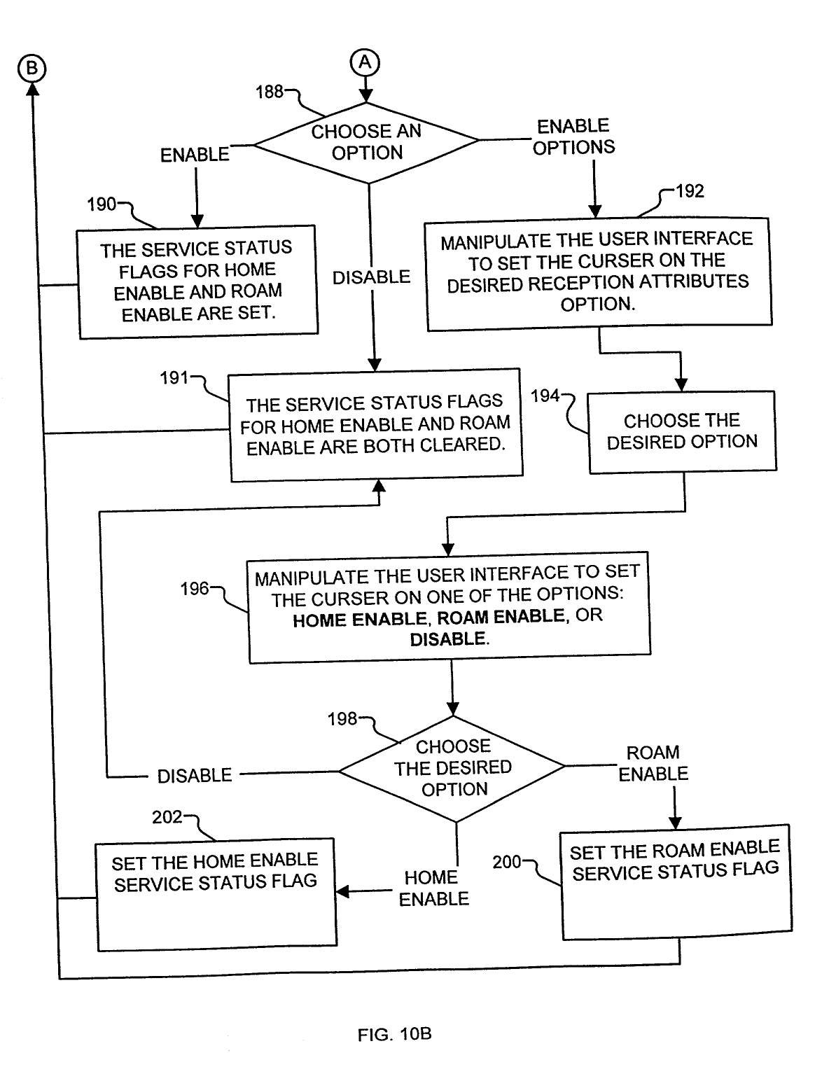

A user of each messaging device 24 can select to enable or disable one or more of the information services, via the user interface of the messaging device, by modifying the directory profile stored in memory of the messaging device, as will be described later in connection with FIGS. 10A-10B. Information service messages from enabled information services are fully decoded by the messaging device for storage and retrieval by the user. In addition, the user can set each information service for roam, home, or roam and home reception, and the temporary folders of messages to which messages may be stored in memory of device for retrieval by the user, via the user interface of the messaging device 24. The particular folder determines how, or if, the user should be alerted to the reception of the message, such as by visual, audio, and/or vibrational notification. For the messaging device 24 example of an alphanumeric pager, the user interface represents a display screen and one or more buttons on the housing of the device.

In addition to information services received as part of a directory of information services, the user of each messaging device 24 may manually enter information services for inclusion in the directory profile of the messaging device, via the user interface of the messaging device or by the user entering the independent information service title on a PC and then loading it onto the messaging device through an interface, such as an infrared port, or through interaction with a provider, for example, on a web page with the independent service title loaded on the device through an OTAP message transmitted by the provider. Such manually entered information services are called herein independent information services. When such independent information services are each enabled by the user, information services messages received for that independent information service are received and fully decoded by the messaging device for storage and retrieval by the user.

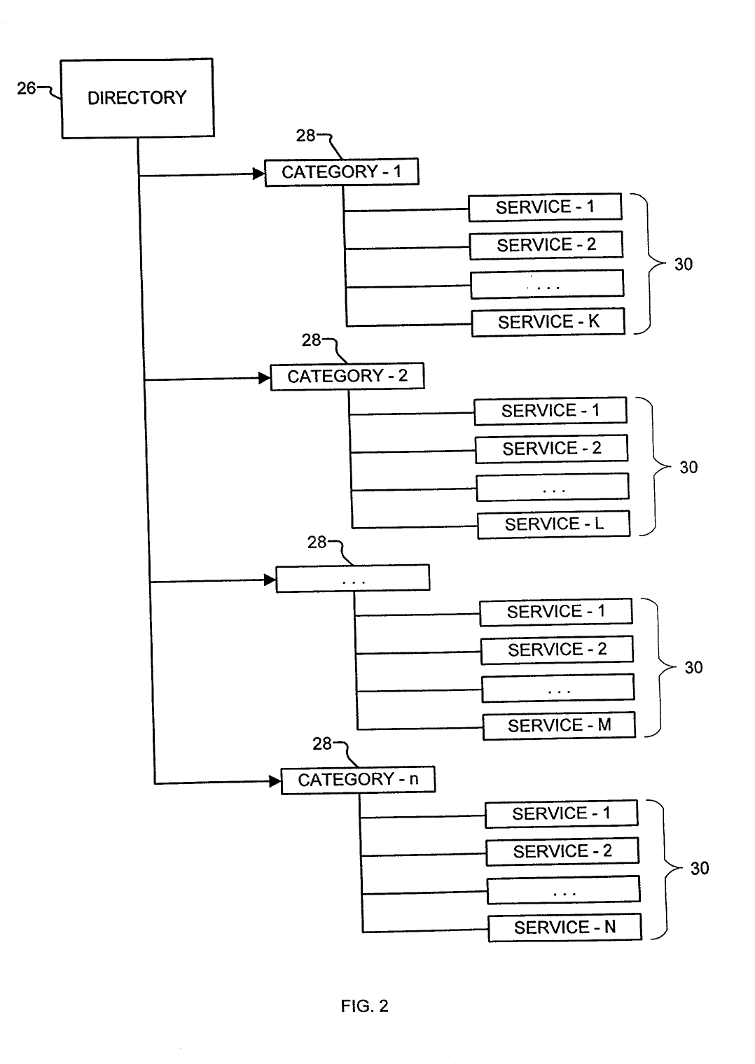

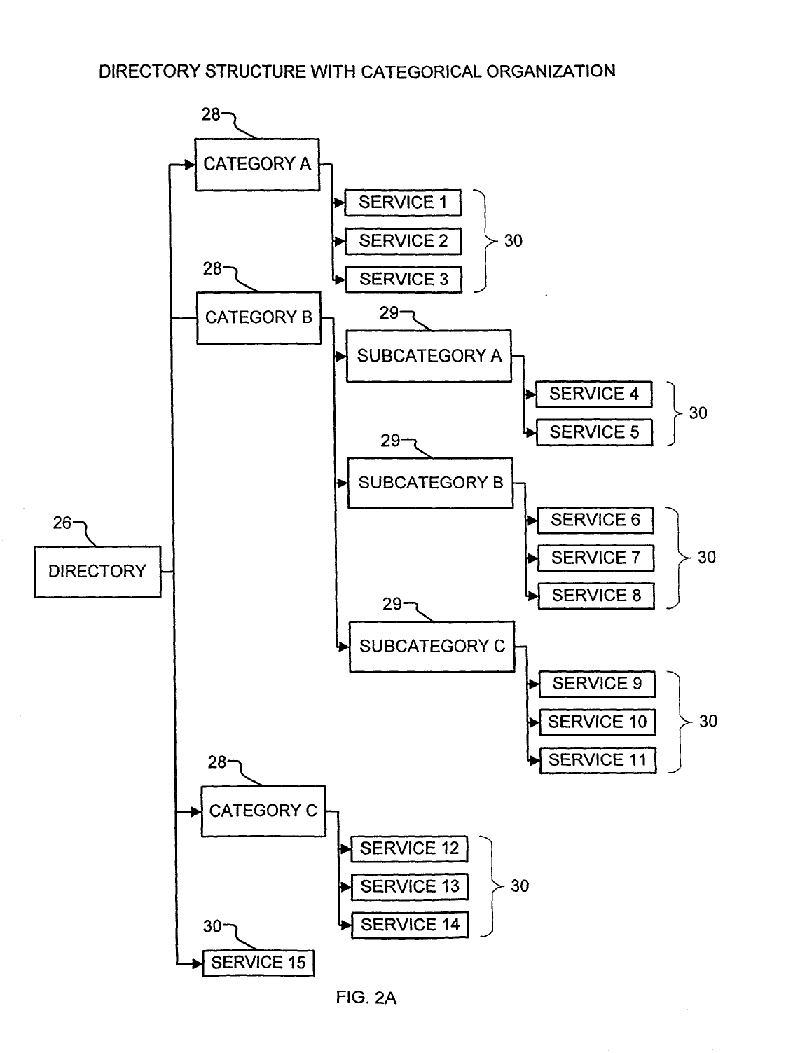

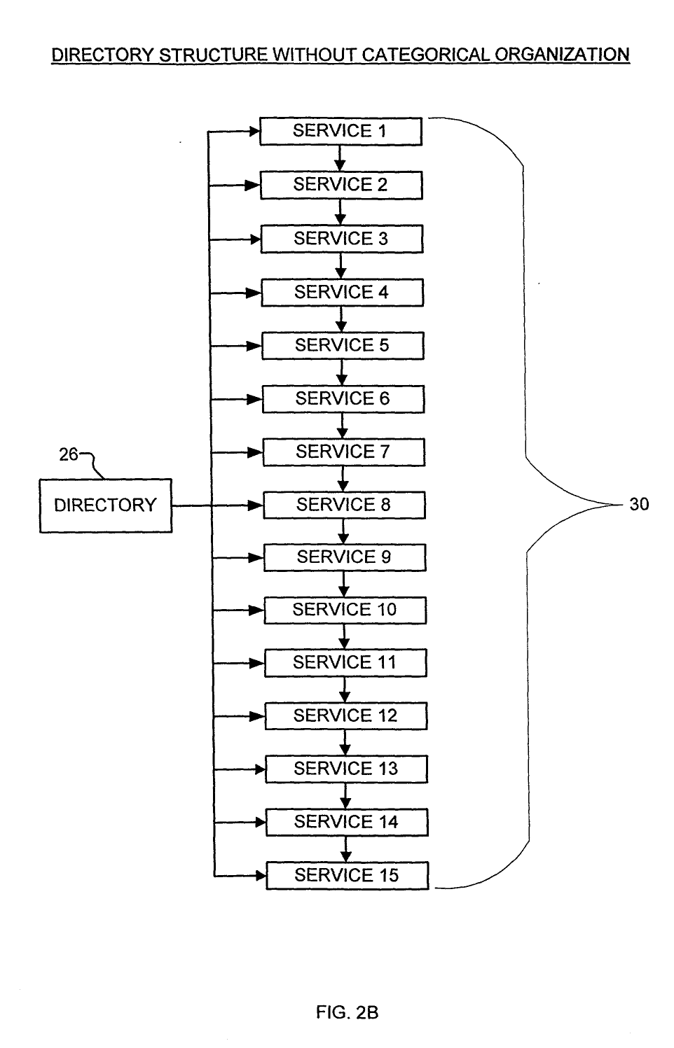

The system 10 uses a directory organization for delivering information services to messaging devices 24 as shown by the examples in FIGS. 2, 2A, and 2B. This directory has information services which may be organized into categories (FIG. 2), categories with subcategories (FIG. 2A), or without categories or subcategories (FIG. 2B). In the example of FIG. 2, the data structure has a multi-tier hierarchical addressing scheme having for a directory 26, one or more first level categories 28 under the directory, and one or more base level information services 30 under each category, where n represents the number of categories and K, L, M, and N illustrates the number of information services under different categories. In the example of FIG. 2A, the data structure can have zero or more first level categories 28, zero or more second level subcategories 29 under one or more categories 28, and information services at the base level of the directory 30, directly associated with a category 28 (e.g., CATEGORY A and C) and/or directly associated with a subcategory 29 (e.g., SUBCATEGORY A, B, and C). An information service 30 may be associated directly under the directory, as for example of SERVICE 15. The illustrated directories are exemplary, other data structures with one or more tiers of categories, subcategories, and further subcategories may be used. A simple flat directory may be used with only information services 30 in the example of FIG. 2B.

The directory organization defines the set of directory messages to be sent to messaging devices to instruct the messaging devices in building a directory profile stored in the devices. After the directory profile is established, changes in the directory organization may be provided to the messaging device in directory messages to update their directory profile in accordance with such changes in directory organization with respect to categories, subcategories, and information services. The directory profile in memory of each messaging device maintains the hierarchical structure of the organized directory. For each directory in system 10, only a single PSA is necessary for wireless routing of messages to messaging device 24.

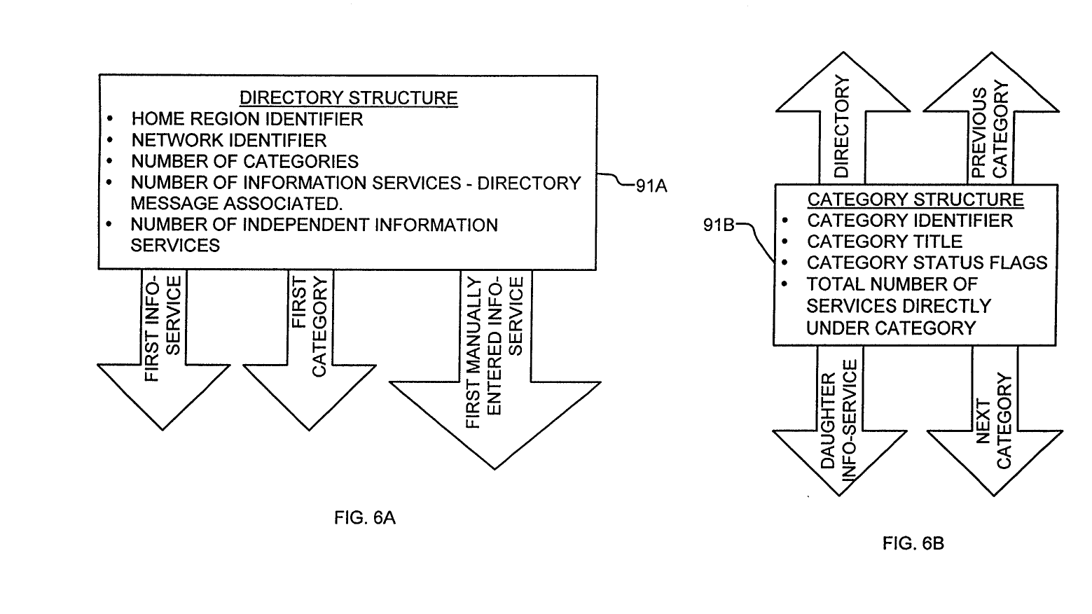

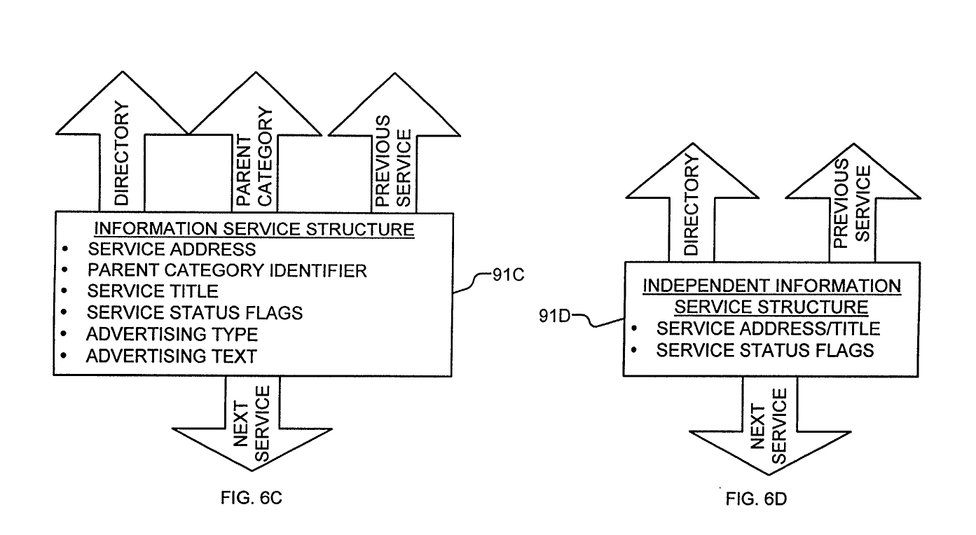

The directory organized by system 10 at the service provider 14 does not include independent information services, as these services are not part of the directory organization defined by directory messages sent to messaging devices 24. Independent information services are described in more detail below in connection with FIGS. 6D, 11, and 13C.

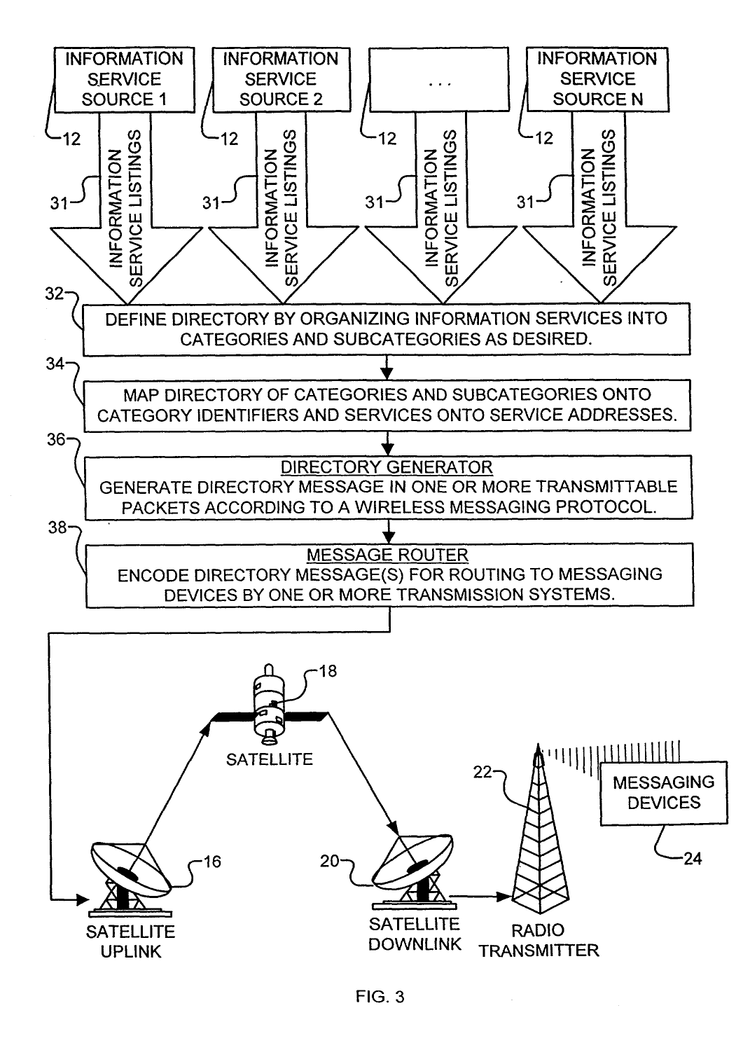

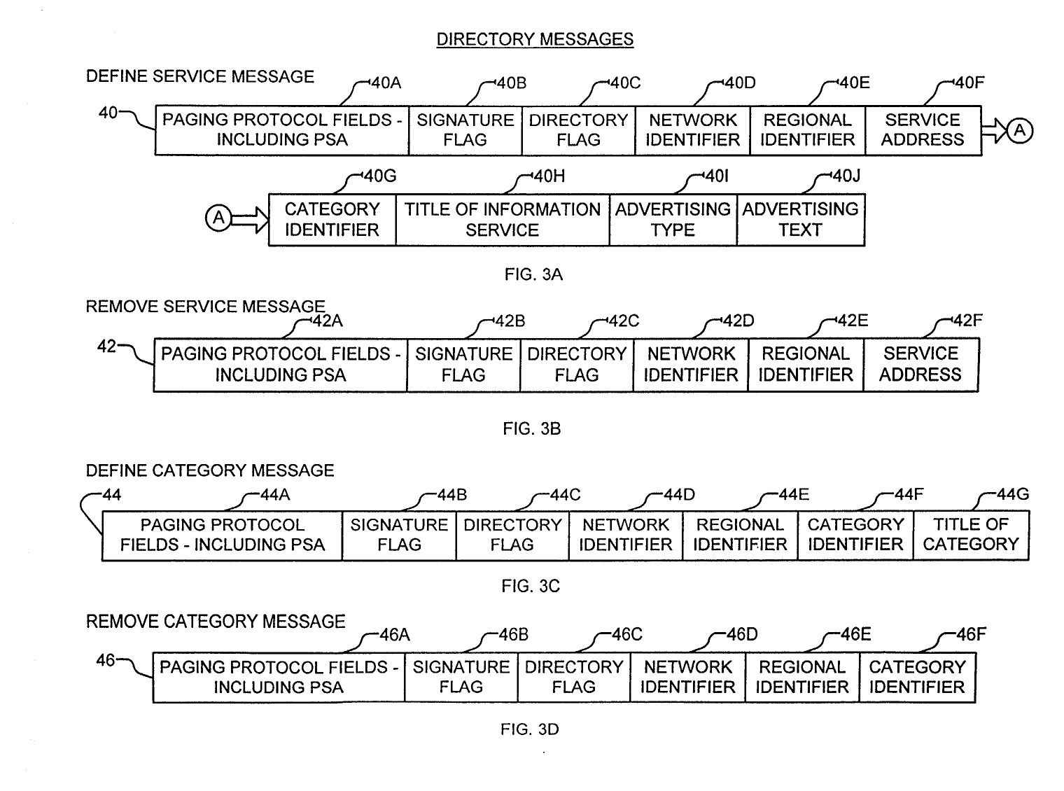

Referring to FIG. 3, the construction, encoding, and transmission of directory messages is shown. The information content to be transmitted in information service messages for each information service originates from information service sources 12. Each of the sources 12 provides lists of information service topics 31 to service provider 14 which can then be organized by a system administrator into categories and subcategories, if any, according to similar attributes of such information services, as shown for example in FIG. 2A (step 32). For example, a category may be football scores, subcategories may be college football or professional football, and then different colleges may be listed as information services under the college subcategory, and different professional teams as information services under the professional subcategory. In another example, a category may have no subcategories, such as a stock market indices category having different stock market average information services, or a weather category may list weather information services for different major cities. In the simplest example, directory elements can represent a list of information services without any relationship to a category, as shown in the example of FIG. 2B. The computer server of the service provider 14 may have a user interface (such as a keyboard, mouse, and display) facilitating a system administrator in organizing the directory into different categories, subcategories, and information services in a directory organization.

After step 32, the computer server of the service provider 14 automatically maps the categories and subcategories with unique category identifiers, and information services with unique information service addresses (step 34). Such information service addresses are addresses different from the PSA of a directory, and thus do not represent signaling addresses used for reception. Each of the information services 30 has a unique variable length text title with associated fixed length service address. Each of the categories has a variable length text title with associated fixed length category identifier. The information service addresses and category identifiers are each composed of pairs of displayable characters which may be chosen from the seven bit ISO-646-1983E ASCII character set. For illustrative purposes, these addresses and identifiers can be represented by two characters with letters used for categories and numbers for services. In the three-tier directory example of FIG. 2A, the category tree information may be implied in the category identifier, where the first character of the category identifier indicates the category and the second character indicates the subcategory so that, for example, AO identifies category A at the base level of the directory and BC indicates subcategory C under category B. Any displayable ASCII character is permitted for use in the category identifiers and service addresses, the ASCII zero character is chosen arbitrarily to indicate the category level in category identifiers. The association of information services to categories in the example of FIG. 2A may or may not be apparent from their addresses, as their hierarchal structure is maintained in a linked list of the directory profile, as will be described later. The addressing scheme also permits messaging devices to use the simple flat directory, as shown in FIG. 2B, where all information services are organized on a single base level under the directory. Such a directory organization would be stored as a linked list of information services in the messaging devices, which may allow implementation of the invention in messaging devices of limited processing power without affecting implementation on more capable devices.

The computer server of the service provider 14 generates a set of directory messages which are composed of displayable characters from the seven bit ISO-646-1983E ASCII character set in one or more transmittable packets according to the wireless messaging protocol used in system 10, such as FLEX described earlier (step 36). The directory messages are formatted in this displayable ASCII strings so that the messages can be processed into normal wireless transmissions to messaging devices 24. The data structures of different types of directory messages are described later below in connection with FIGS. 3A-D. The directory messages are then encoded as normal messages in accordance with a messaging network protocol compatible with the transmission system represented by 16, 18, 20, and 22, such as the Telocator Network Paging Protocol (TNPP), at step 38. Each directory message generated at step 36 includes a PSA as its radio signaling address, and is fully decoded by all messaging devices with that PSA in their internal lists of radio signaling addresses that are decoded upon reception if other identifying information of the directory message matches that stored in the messaging device, as will be described. The messaging devices 24 are programmed to process the message in accordance with the structure of the different types of directory messages (FIGS. 3A-D).

When an entire directory is transmitted, it is transmitted in a set of directory messages for building the directory profile in the messaging devices 24 in accordance with the information services, categories, or subcategories of the directory organization. Each of the directory messages in the set can be transmitted at any time convenient to the service provider 14. However, preferably, the set of directory messages is sent periodically, such as once each day, to assure that each messaging device 24 recently added in system 10 is provided with a directory profile within that periodic interval.

Referring to FIG. 3A-D, there are four types of directory messages: (1) a define service message 40 provides information about a specific information service in the directory, as shown in FIG. 3A; (2) a remove service message 42 removes the information about a specific information service from the directory, as shown in FIG. 3B; (3) define category message 44 provides information about a specific category in the directory, as shown in FIG. 3C; and (4) remove category message 46 removes the information about a specific category from the directory, as shown in FIG. 3D. Each type of the directory messages represents a series of alphanumeric characters in accordance with the particular directory organized at step 32 (FIG. 3).

The define service directory message 40 has the following data fields: paging protocol fields 40A, signature flag 40B, directory flag 40C, network identifier 40D, regional identifier 40E, information service address 40F, category identifier 40G, title of information service 40H, optional advertising type 401 and advertising text 40J. The paging protocol fields 40A are parts of a typical wireless networking protocol used for transmission and eventual decoding of the message by messaging devices. Its structure depends on the particular protocol used in system 10 and includes a PSA as the radio signaling address (e.g., capcode) of the message. The paging protocol fields may be in accordance with the FLEX Alphanumeric Protocol, as described for example in, FLEX Protocol Specification and FLEX Encoding and Decoding Requirements, Issue G1.9b, Document Number: 6881139B01, Motorola Corporation, to enable decoding of the message by a compatible decoder in the messaging devices 24. The signature flag 40B is a character, such as “]”, indicating that the message is part of system 10. The directory flag 40C is a character which differs depending on the type of directory message. For the define service message, the character may be for example, “.” The network identifier 40D follows and consists of one alphanumeric character that identifies the network that is broadcasting the message. The region field 40E is a two character field with a unique identifier associated with different coverage regions of transmission systems which can refer to geographic locations, cities, states, countries, and is used to enable the messaging devices to distinguish directories when the service provider provides different directories based on location. The service provider sets this identifier based on the region of the transmission system through which the directory is to be sent. The service provider maintains a list of identifiers associated with regions. In this manner, different directories may be tailored for particular locations, such as weather information, tourist information, restaurants, local news, or the like. Next, the information service address 40F is provided representing a unique address encoded in two displayable characters from the standard (ISO 646-1983E) ASCII character set. The category identifier 40G provides a unique identifier of the category, under which this information service is directly associated. The category identifier 40G is also encoded in two displayable characters from the standard (ISO 646-1983E) ASCII character set. If the information service is not associated with a category, then it is at the base level of the directory; this is indicated by a reserved value of the category identifier, e.g., “00”. An example of an information service not associated with a category is shown by SERVICE 15 of FIG. 2A. If the messaging device is programmed to assemble the directory profile as a list of information services without organization into categories, then it ignores the two character category identifier, to provide a directory such as shown for example in FIG. 2B. The title of the information service 40H follows the category identifier 40G and is composed of a contiguous string of alphanumeric characters. An advertising type flag 40I follows the information service title 40H indicating both the conclusion of the title and whether any advertising text that follows should precede or follow, indicated by a value, e.g., “ˆ ” or “|”, respectively, when messages for this information service are displayed. The text of the advertisement 40J follows in a string of alphanumeric characters concluding define service message 40. If no advertising text is included, then no advertisement will be embedded in the display of messages received for this information service. As will be described later, a messaging device 24 in response to receiving a define service message creates an information service structure in the linked list of the directory profile of its memory as shown in FIG. 6C.

The remove service directory message 42 has the following data fields: paging protocol fields 42A, signature flag 42B, directory flag 42C, network identifier 42D, regional identifier 42E, and information service address 42F of the information service to be deleted from the directory profile stored in memory of the messaging device. The fields 42A, 42B, 42D, and 42E are the same as described for fields 40A, 40B, 40D, and 40E, respectively. Directory flag 42C is a character which differs depending on the type of directory message. For the remove service message, the character may be for example, “-”. As will be described later, in response to receiving a remove service message, a messaging device 24 deletes the information service structure associated with information service address 42F in the link list of the directory profile of its memory, while preserving the linkage of other records of the link list which may be effected by the deleted structure. Optionally, information services may also be removed from the directory by the process of decay. That is, information services are given a lifetime or decay period, e.g., 30 days. If this lifetime passes without the device receiving a single information service message with that information service address or a define service message with that information service address, then the data structure in the device directory corresponding to the information service is removed.

The define category directory message 44 has the following data fields: paging protocol fields 44A, signature flag 44B, directory flag 44C, network identifier 44D, regional identifier 44E, category identifier 44F, and title of category 44G. The fields 44A, 44B, 44D, and 44E are the same as described for fields 40A, 40B, 40D, and 40E, respectively. Directory flag 44C is a character which differs depending on the type of directory message. For the define category message, the character may be for example, “,”. The category identifier 44F provides a unique identifier of the category encoded in two displayable characters from the standard (ISO 646-1983E) ASCII character set. The title of the category 44G follows the category identifier 44F and is composed of a contiguous string of alphanumeric characters. The information from a define category message is incorporated into the directory profile with all services directly associated with the given category organized below the category in the directory, e.g., as shown in FIG. 2A. (Messaging devices that do not support categorical organization of the directory structure recognize and do not process category messages and so construct directory profiles that are simple lists of information services, e.g., as shown in FIG. 2B. ) As will be described later, a messaging device 24 in response to receiving a define category message creates a category structure in the linked list of the directory profile of its memory as shown in FIG. 6B.

The remove category directory message 46 has the following data fields: paging protocol fields 46A, signature flag 46B, directory flag 46C, network identifier 46D, regional identifier 46E, and category identifier 46F of the category to be deleted from the directory profile stored in memory of the messaging device. The fields 46A, 46B, 46D, and 46E are the same as described for fields 40A, 40B, 40D, and 40E, respectively. Directory flag 46C is a character which differs depending on the type of directory message. For the remove category message, the character may be for example, “_”. As will be described later, in response to receiving a remove category message, a messaging device 24 deletes the record of the category associated with category identifier 46F in the linked list of the directory profile of its memory, while preserving the linkage of other records of the link list which may be affected by the deleted record. Ideally information services associated with the category to be removed will have either been independently removed through the appropriate set of remove service messages or reassigned to another category through the appropriate set of define service messages prior to the remove category message. If not, then those information services associated with the category will not be accessible through interaction with the directory and will consequently remain either disabled or home and/or roam enabled on the device until they are either removed from the directory by remove service messages or decay or are assigned another category through define service messages. (Messaging devices that do not support categorical organization of the directory recognize and do not process remove category messages.)

The messaging devices 24 in processing a received one of these directory messages 40, 42, 44, and 46, only directory messages including the network identifier that matches that previously stored in the messaging device and a region identifier that matches the home region identifier previously stored in the messaging device, are processed. The network identifier and region identifier are programmed for storage in each messaging device when the user of the device subscribes to a directory of information services with the service provider.

The complete directory is the compilation of the complete set of define service and define category directory messages. However, the list of information services may be provided without categories, as described earlier, by the messaging device without categorical organization being programmed to ignore define and remove categories messages, and in define service messages ignoring category identifier 40G.

If directory organization is later revised, then steps 32, 34, and 36 will, in addition to the set of directory messages defining that organization, send remove service and remove category directory messages to remove any categories or information services which are no longer present in the revised directory.

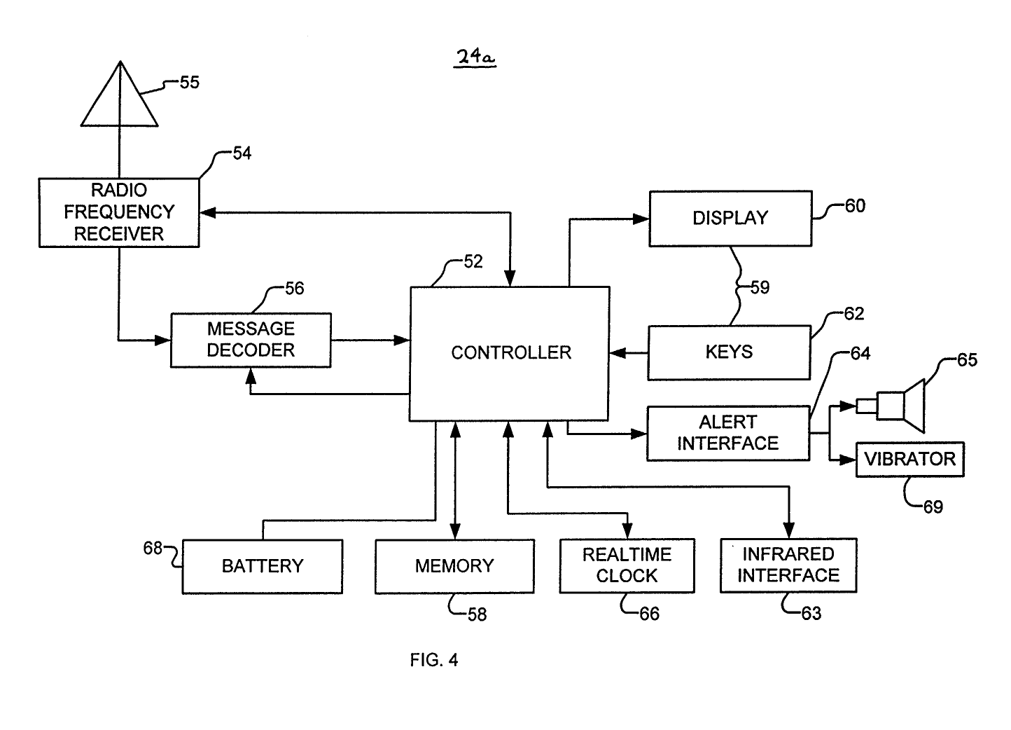

A diagram of such messaging devices 24 in system 10 provided by one-way alphanumeric pager 24a (FIG. 1) is shown in FIG. 4 having components of a typical alphanumeric pager, in which its controller 52 is programmed to operate within system 10. The messaging device includes a radio frequency (RF) receiver 54 for the reception, via antenna 55, and demodulation of coded transmissions broadcast by the transmission system's radio transmitter antenna 22 (FIG. 1) in range of the unit, and a message decoder 56 for decoding messages received from demodulated data from the RF receiver 54 in accordance with the messaging protocol used in system 10. The message decoder 56 operates in response to the controller 52 to decode each message. The decoder 56 provides to the controller 52 the radio signaling address of each message received, and the controller 52 directs further decoding of all or part of the message, if the radio signaling address matches one of the radio signaling addresses stored in memory of the controller 52 or memory 58. In the alternative, the decoder 56 may have memory storing the radio signaling addresses to be received by the messaging device. Each messaging device may operate to receive and decode one or multiple radio signaling addresses depending on the capability of the messaging device. The controller 52 controls the operation of the messaging device in accordance with its stored programming (software) in memory of controller 52 or memory 58.

The controller 52 can operate in response to received Over The Air Programming (OTAP) messages to program the device, such as adding, deleting, or changing a radio signaling address which must be included in messages the messaging device will decode, or other parameters of operation such as network identifier or home region identifier for the messaging device. OTAP messages are conventionally used in the paging industry to program messaging devices, such as pagers. The controller 52 may output information to a display 60 providing a representation of the directory profile of information services in one or more screens, and output information received from enabled information service messages, or page messages of the prior art. Keys 62, such as pushbuttons, are provided through openings in the housing of the paging unit with circuitry to enable the user to interface with the controller 52 to scroll and select items listed in a representation of the directory profile, or through stored information service message from enabled information services, or through page messages. Display 60 and keys 62 represent the user interface 59 for the messaging device. An infrared interface 63 provides an interface for data input and output to the controller 52 to allow loading of external information to the controller and delivery of information from the controller.

In addition to operating in system 10, the messaging device 24a may operate as a typical pager to receive page messages. An interface 64 to an acoustic transducer 65, or vibrator 69, may be provided to enable the controller 52 to output audio or vibrational alert signals upon receipt of a message. Other components typical of paging units may also be included in messaging device, such as a real-time clock 66 to provide a source of timing (date and time), or a power source (battery) 68. Since all of the components of messaging devices 24a are present in typical messaging devices such as alphanumeric pagers, the present invention can be readily incorporated into existing designs of such messaging devices by adding and changing certain software, such as in controller 52, to make the device operate in system 10. Application to an alphanumeric pager as device 24a is shown only as an example of a messaging device 24, and as stated earlier, the present invention may be incorporated into any device capable of receiving and decoding signals from transmitter 22.

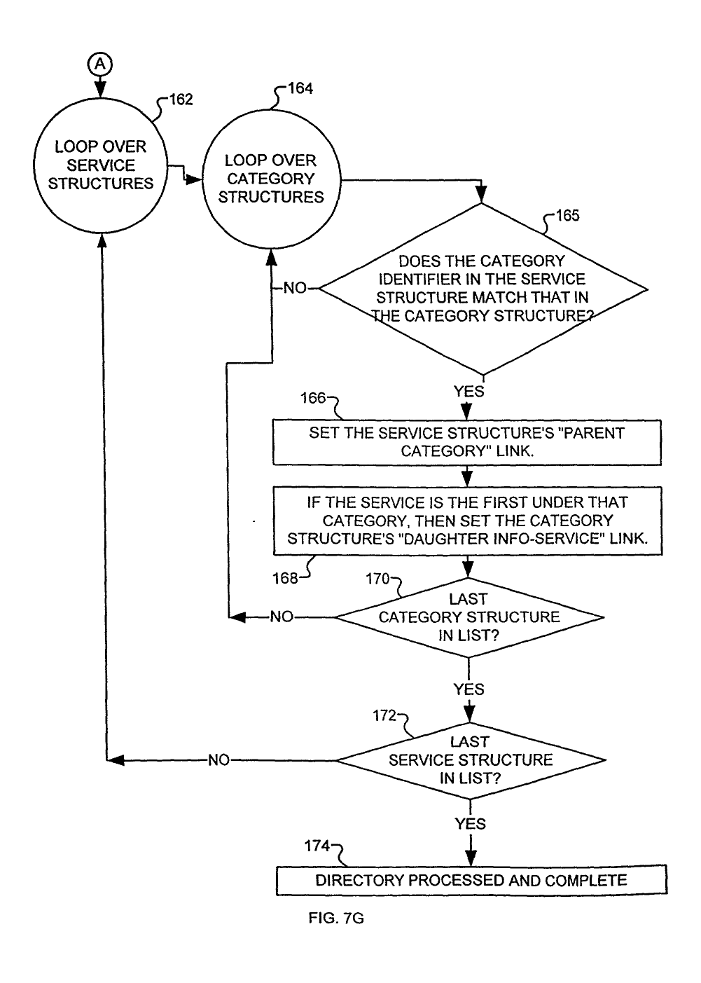

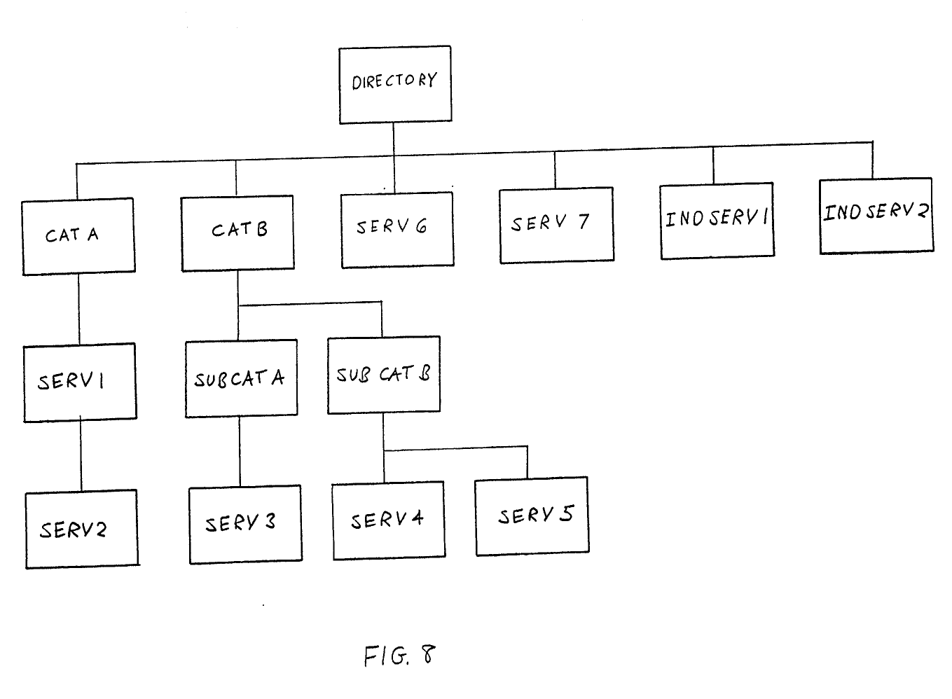

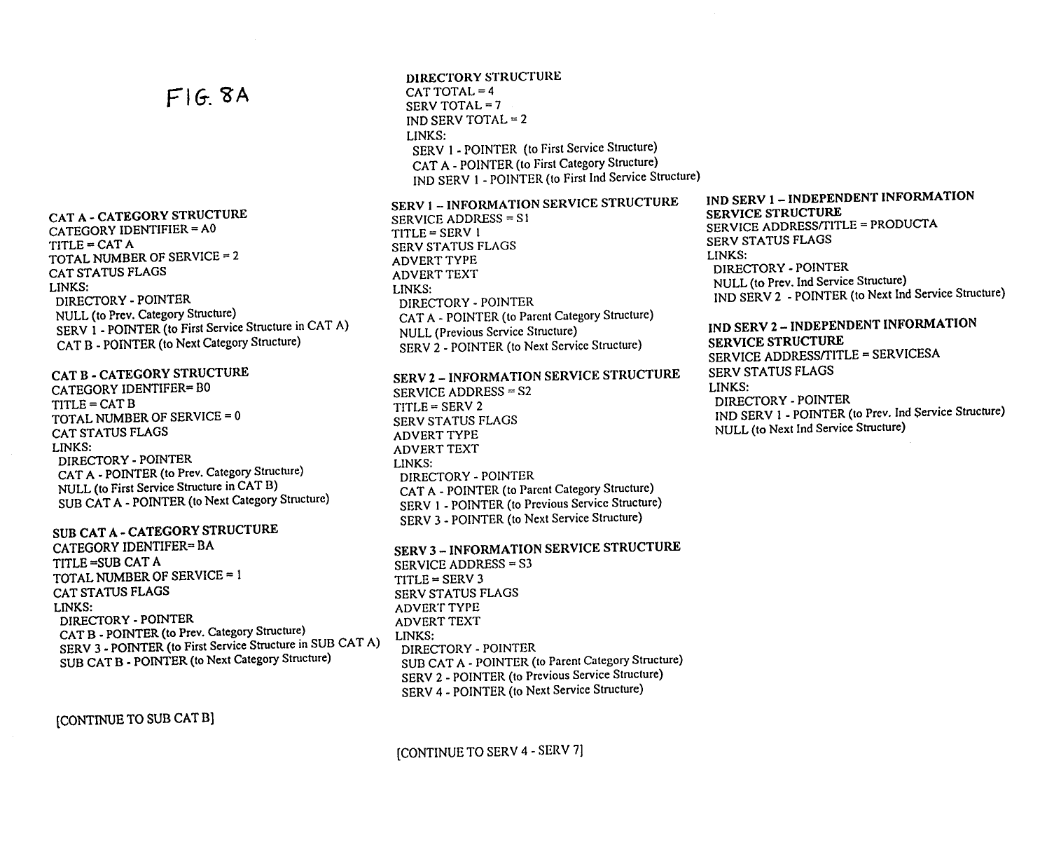

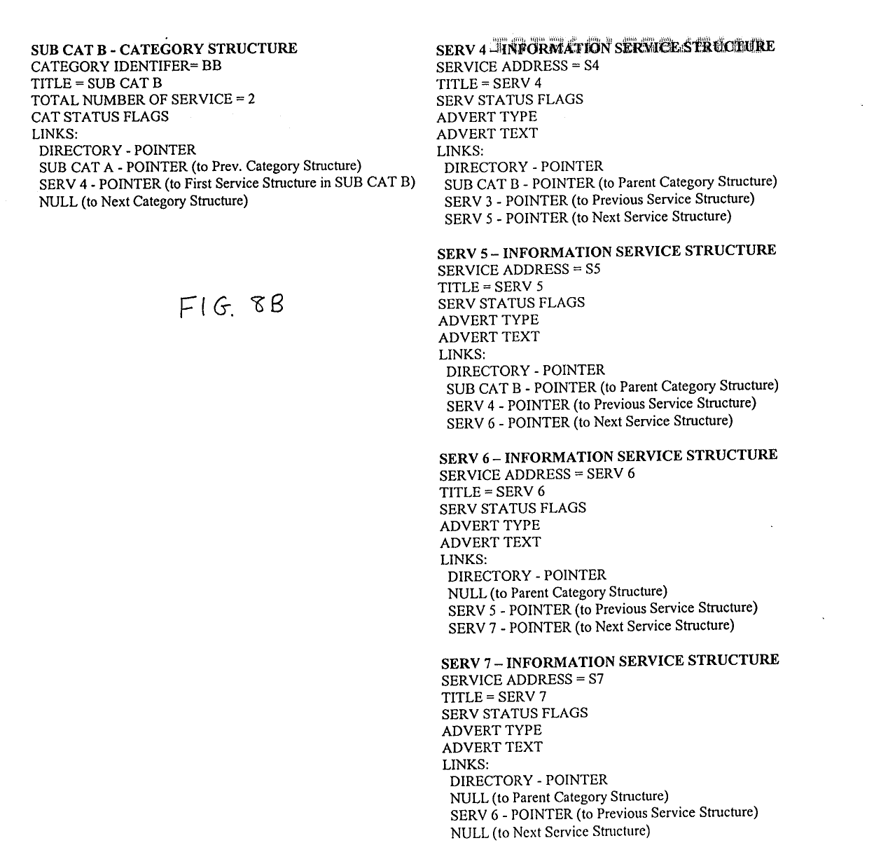

Each messaging device 24 stores in its memory a directory profile built and updated in accordance with directory messages received from one or more subscribed directories. The directory profile represents a link list of different types of structures as described latter in connection with FIGS. 6A-6D, and illustrated by example in FIGS. 8A-8B for the directory of FIG. 8.

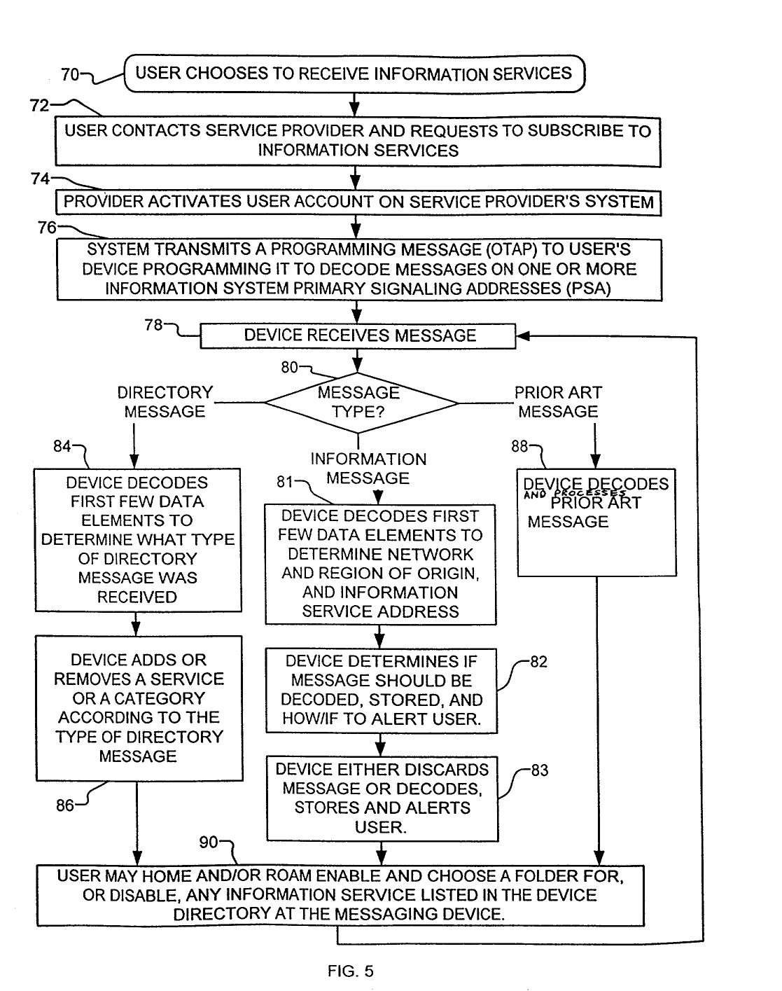

Referring to FIG. 5, an overview of the operation of the system 10 at each of the messaging devices 24 in system 10 is shown. After the user has decided to receive information services, the user determines which directory of information services they are interested in receiving if more than one directory is being offered by the service provider (step 70). The user may be made aware of the directory of information services such as by Internet search to the world wide web (WWW) site of the service provider, distributed promotional documentation, or discussion with a representative of the service provider. The user contacts the service provider 14, in person, by telephone, or through a WWW page order form on the web site, to start the service (step 72), and then the service provider activates a user account at the service provider (step 74). The service provider 14 programs the messaging device 24 to decode the radio signaling address, i.e., PSA, which the service provider 14 uses to transmit directory and information service messages, through an OTAP message sent to the messaging device (step 76). If the user has subscribed to multiple directories, the PSA for each directory is sent through one or more OTAP messages. The OTAP message includes a network identifier to identify the network in which the messaging device will receive directory messages and information service messages, and a home region identifier to identify the home region of delivery of messages. In response to the OTAP message sent, the messaging device 24 adds the PSA(s) into memory of the messaging device 24 stored list of radio signaling addresses the device will decode upon reception, and sets the device's network identifier and a home region identifier in a record of the first level of the linked list of the directory profile. The home region identifier of each messaging device 24 may be later reset if the user of the device wishes by another Over The Air Programming (OTAP) message transmitted by the service provider 14. As the system 10 may use the same PSA over several networks, and one or more networks may have the same or different service providers, the network identifier is associated with the service network from which the messaging device is meant to process messages. Since messaging devices 24 may roam over one or more geographic regions of coverage, the stored home region identifier enables the devices to identify messages associated with other regions for roam region reception, if set as well as when messages are from the home region. In the alternative, the directory of information services may be a feature offered by the manufacturer (or distributor) of messaging devices, and as such, the messaging device may be programmed as described by step 76 without requiring the user to separately arrange for delivery of the directory of information services.

The messaging device 24 will now receive and decode any directory message at the PSA(s) with a set signature flag, whose encoded network identifier and region identifier are the same as the messaging device's network identifier and home region, respectively, stored in its memory. Further, the messaging device 24 will now receive information service messages at the PSA(s), that are included in the messaging device 24 stored list, but only fully decode and store those information service messages with a set signature flag having an appropriate network identifier to that stored in the device's memory, a region identifier matching a home region identifier if the information service is only home region enabled and not roam enabled, and an information service address included in the message which matches one of the enabled information services at the messaging device. If the account is later closed by the user of a messaging device 24 or the service provider 14, another OTAP message is sent to the messaging device to remove the PSA(s) from the list of signaling addresses the device will decode upon reception.

The messaging device 24 continually monitors for incoming messages on every radio signaling address the device is programmed to decode, and upon receiving an incoming message on the PSA(s) decodes the first data elements which will define the message type (step 78), and determines the message type as being either an information service message, a directory message, or a page message of the prior art (step 80). Information service and directory messages are received on a PSA(s), and prior art messages are processed in the typical manner of the prior art. The signature flag assures that the message is either an information service message or a directory message from a service provider 14, otherwise the message is a paging message of the prior art. If the signature flag is set, the message is a directory message if the directory flag is set to one of the directory types, otherwise the message is an information service message.

Preferably, the PSA(s) are used to send messages in system 10. However, messaging devices may be programmed to identify information service messages and directory messages by their signature flag being set, irrespective of whether they are received on a PSA or another radio signaling address stored in the internal list of addresses on the messaging device.

Upon receipt of an information service message, the first few data fields representing the region identifier (region or message origin), network identifier (network of message origin), and information service address are decoded (step 81). If the information service address matches an address on the list of addresses of information service addresses enabled by the user at the messaging device, and the region identifier and network identifier decoded match the network identifier and home region identifier (and/or roam region identifier) stored in memory of the messaging device, the message is fully decoded, stored in its memory, and the user, if needed, is alerted to the message, otherwise the message is discarded (steps 82-83). Each information service in the stored directory profile in memory of the messaging device has a temporary storage setting used to determine where in memory, i.e., which folder, the message will be stored, and an alert setting determining how (e.g., audio or vibrational), or if, the user should be alerted of the reception of the message.

Upon receipt of a directory message, the first few data fields are decoded and processed to determine whether or not the message should be fully decoded and if the message should be fully processed to update the device directory profile (step 84). The device then adds (or overwrites) or removes a service structure or a category structure from the directory profile according to the type of directory message (step 86). Each directory message is processed independently resulting at all times in a fully functional self-contained directory profile in the memory of the messaging device.

Upon receipt of a message representing a prior art paging message, the messaging device processes (decodes and/or alerts) accordingly (step 88). Prior art messages will have a signaling address stored in memory of the messaging device for receipt of such message, as typical of pagers, but will fail to have the proper signature flag set for system 10. Decoding and processing of the prior art messages may be in accordance with conventional methods of messaging devices of the prior art to decode, store and/or alert users.

The user may enable or disable information services at the messaging device at any time independent of the service provider, without requiring contacting the service provider as in prior art messaging service systems (step 90). Further, the user may at step 90, may home and/or roam enable any information services, and choose a folder for storage of messages for the information service. Step 90 is further described in connection with FIGS. 10A-1OB.

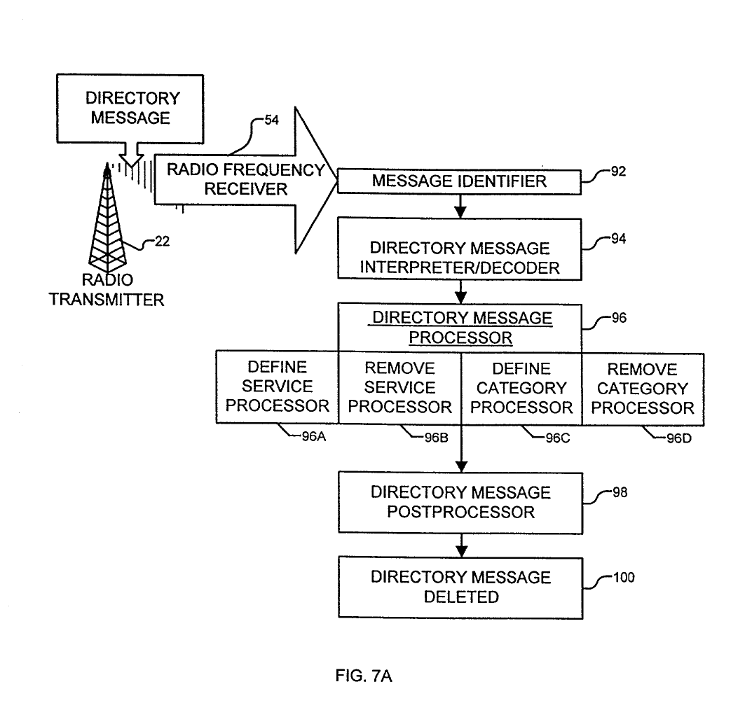

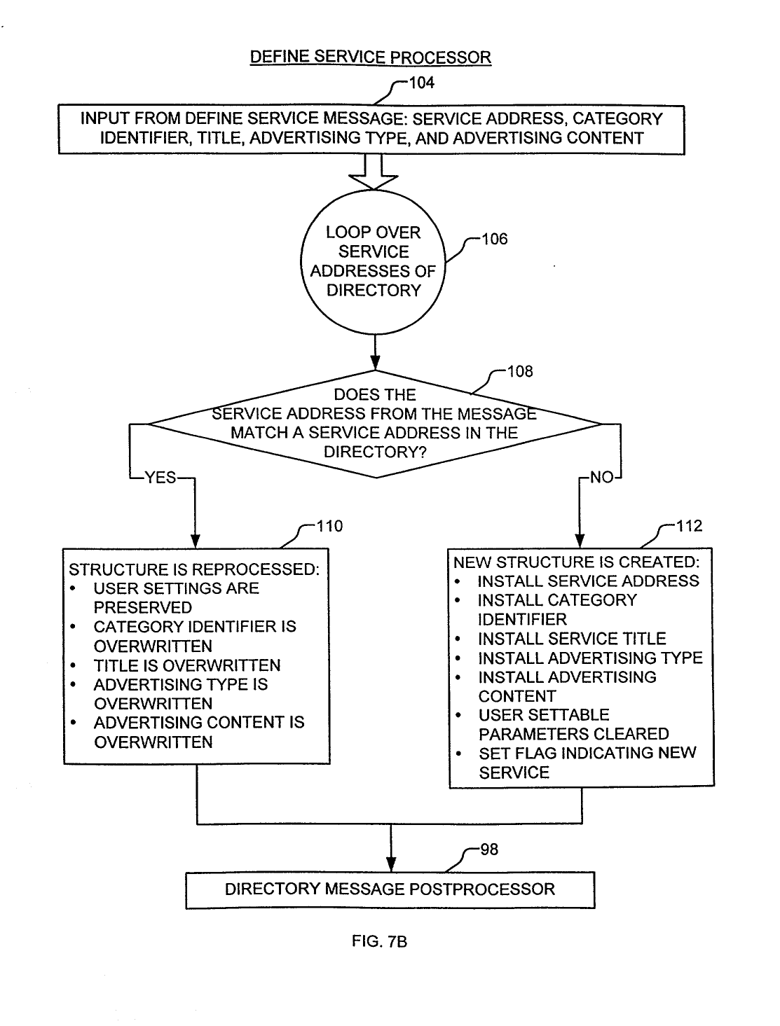

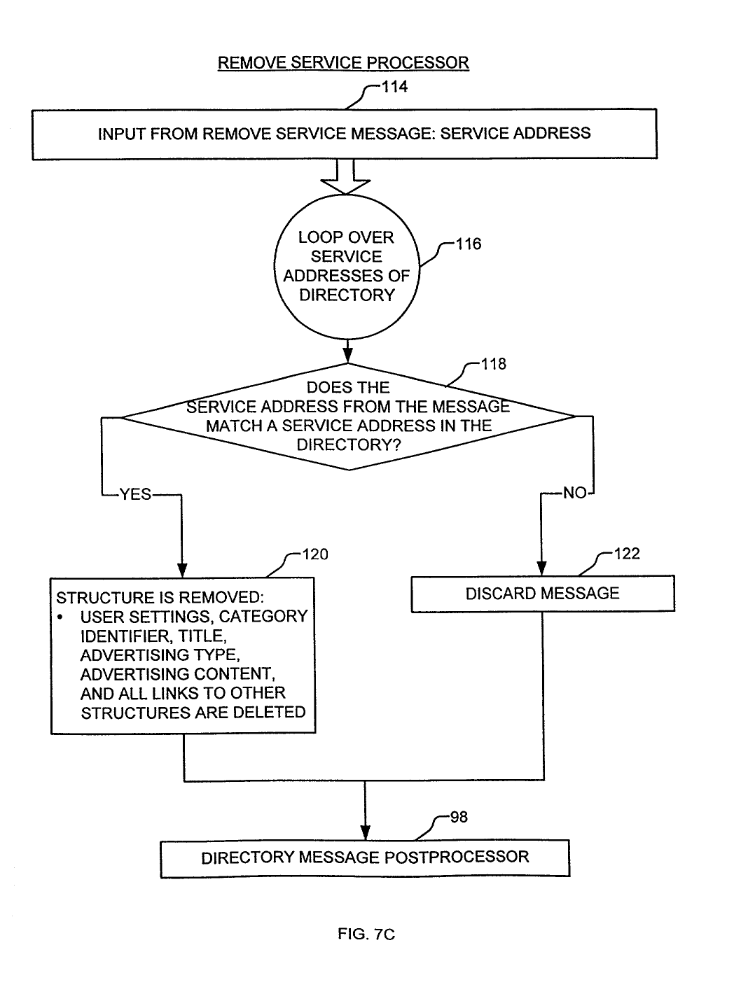

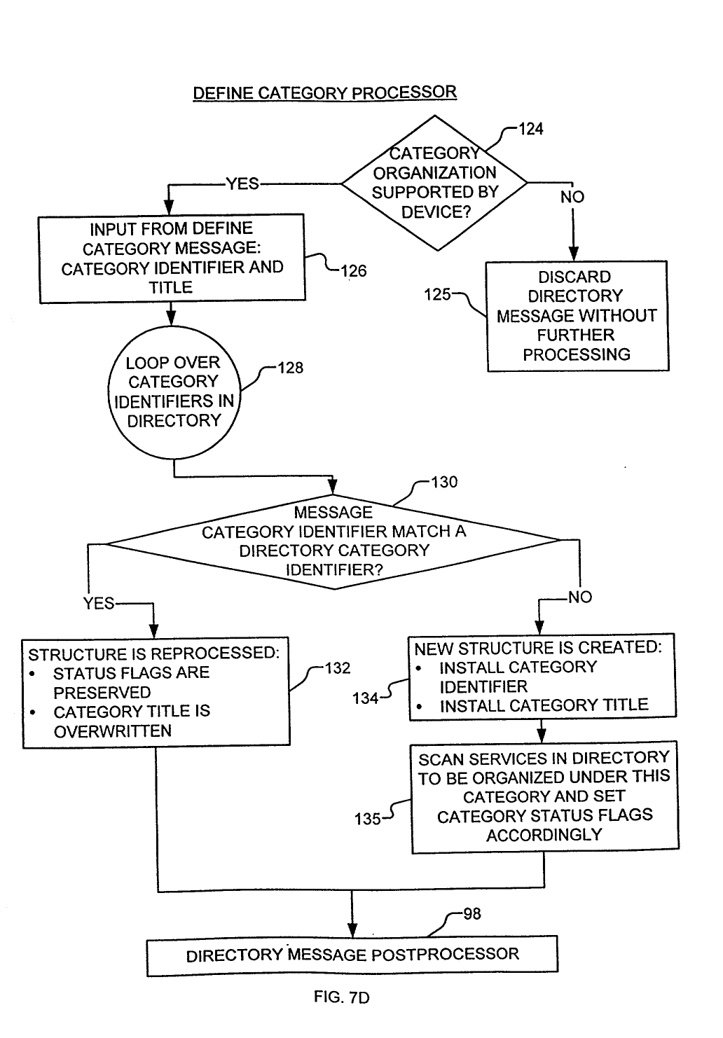

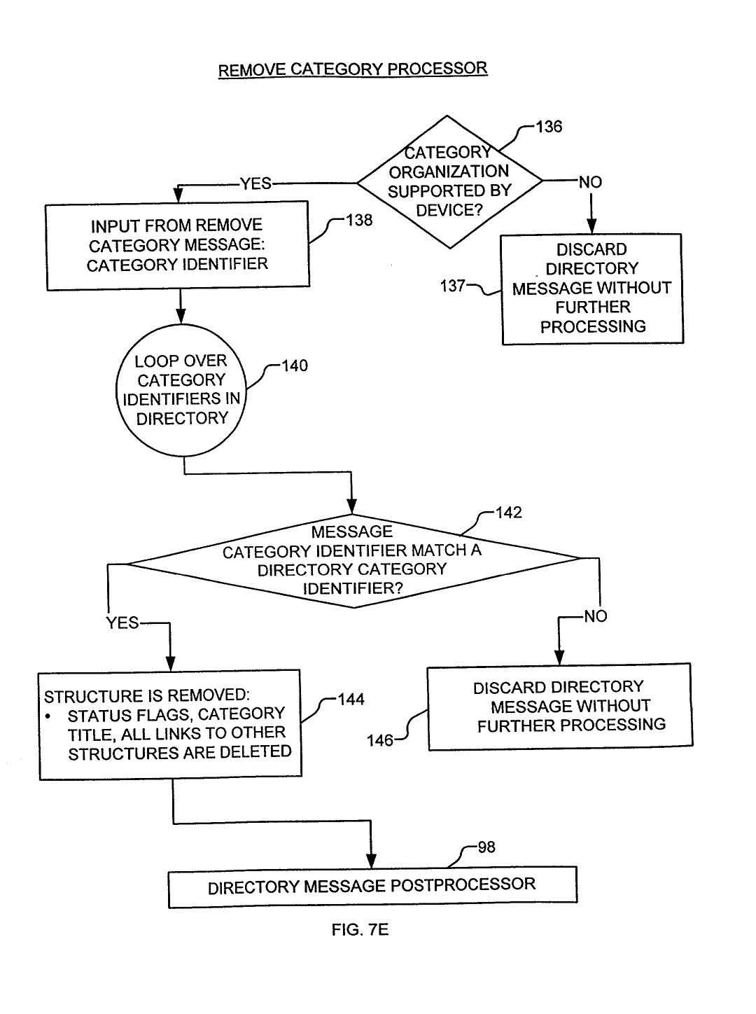

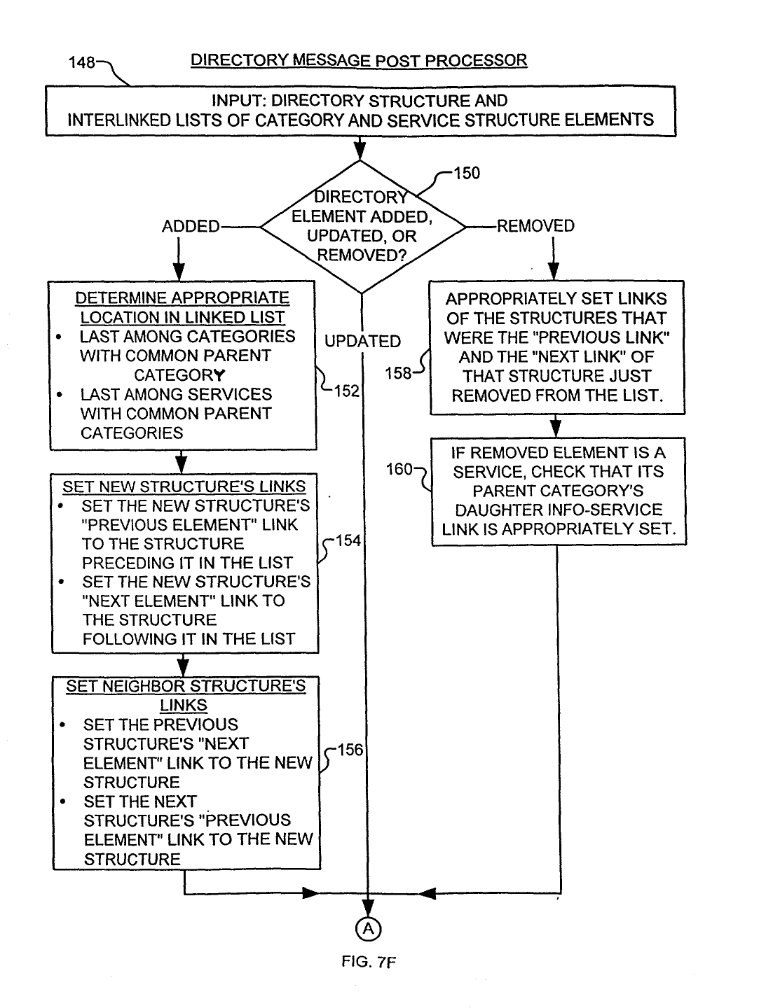

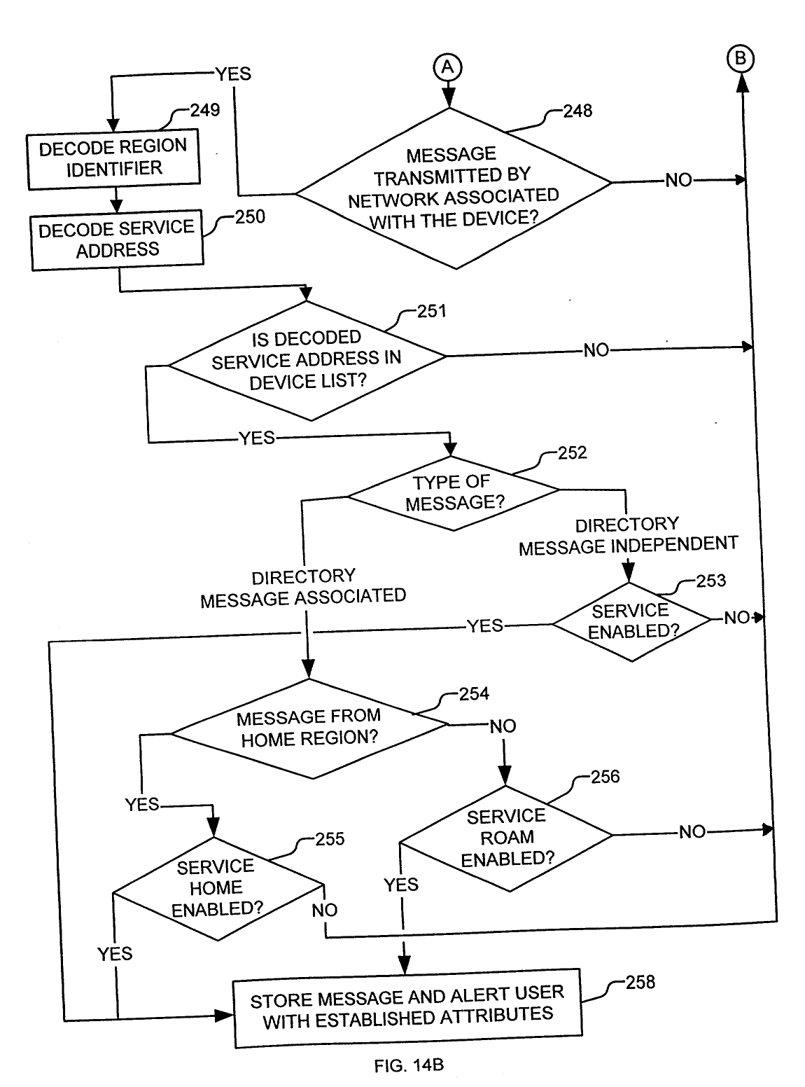

The reception of directory messages of steps 84-86 are described in more detail in FIGS. 7A-7G. The reception of information service messages of steps 81-83 are described in more detail in FIGS. 14A-14B.

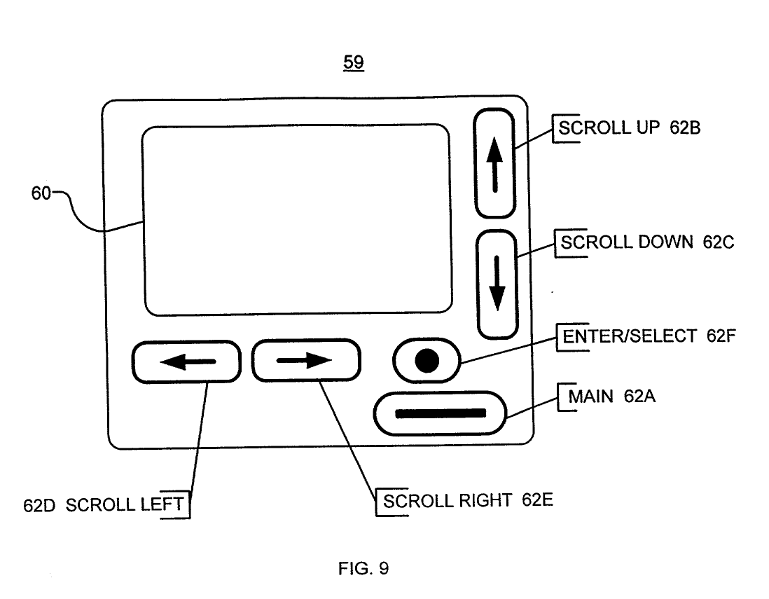

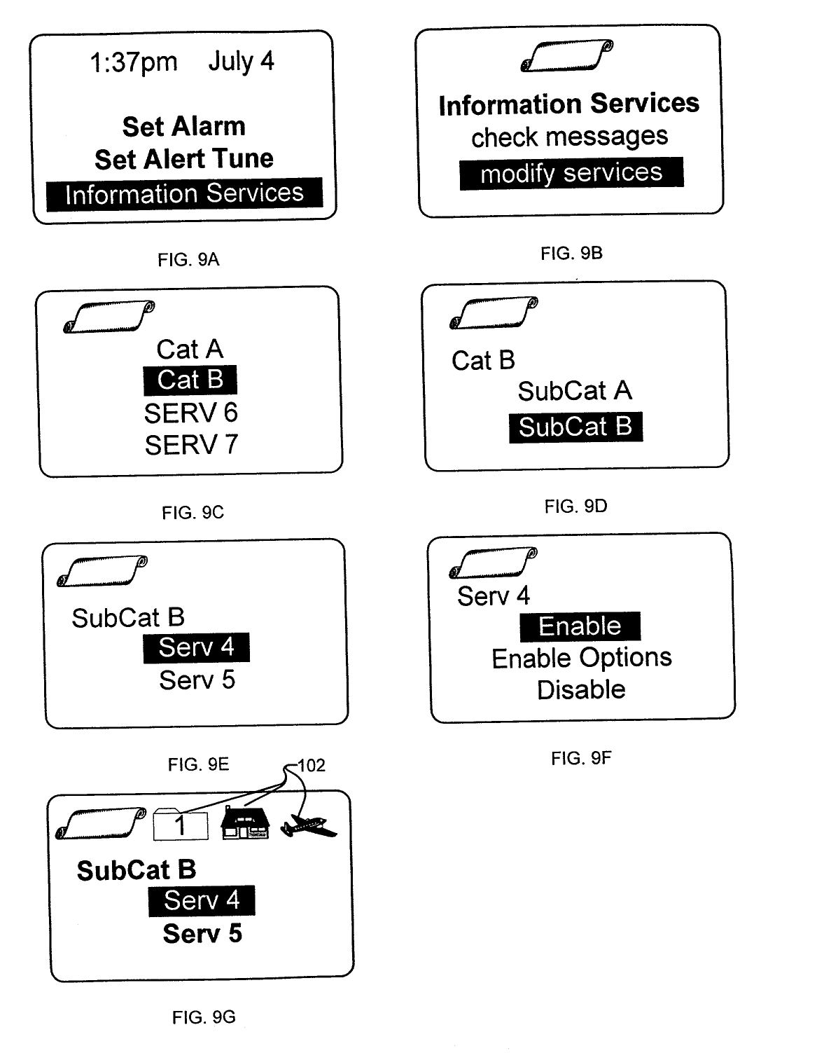

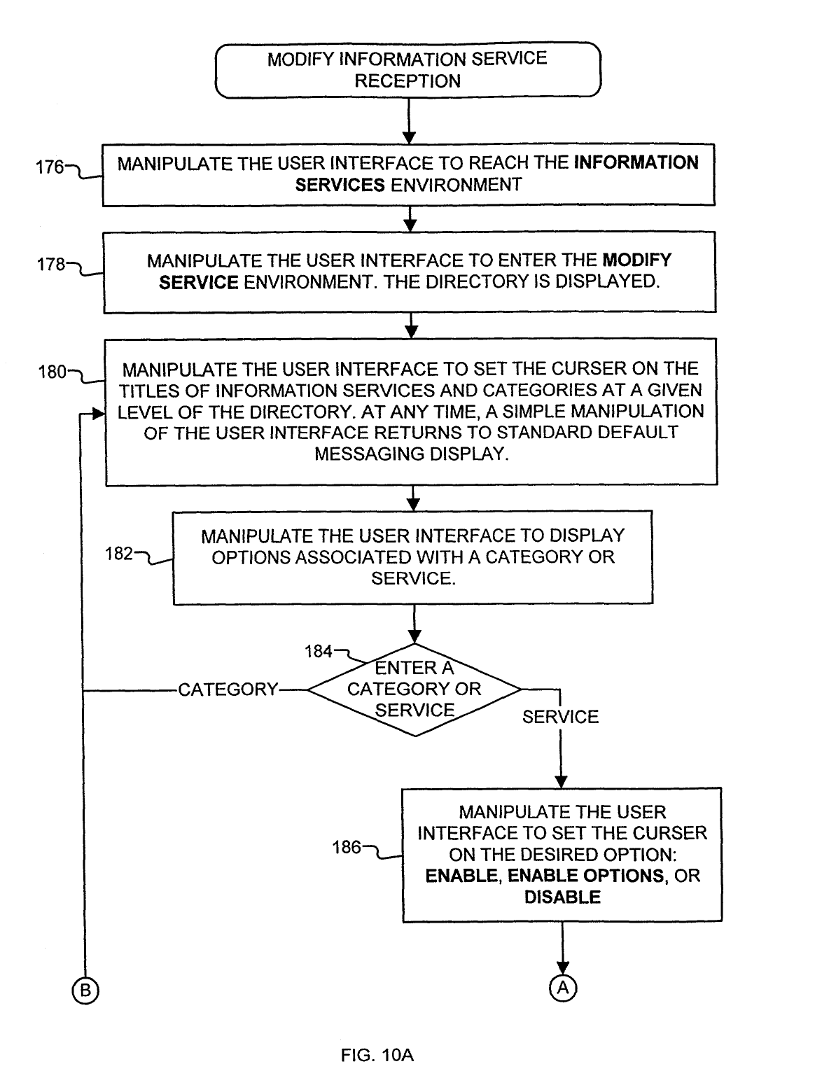

The directory profile in memory of each messaging device 24 in system 10 will now be described. The directory profile is a linked list of four types of data structures 91A, 91B 91C, and 91C shown in FIGS. 6A-6D. Only data structures 91A-C result from received directory messages from service provider 14, while data structure 91D is generated in response to a user manually entering an independent information service at their messaging device or by the user entering the independent information service title on a PC and then loading it onto the messaging device through an interface, such as an infrared port, or through interaction with a provider, for example on a web page with the independent service title loaded on the device through an OTAP message transmitted by the provider. Arrows in the figures represent links to other structure identified in the arrow. The directory structure 91A serves as the top link to the directory and has links to the first information service structure 91B, the first category structure 91C, and the first independent information service structure 91D. Linkage to the first information service is provided by storing in the directory structure 91A the address of the location in the device memory 58 (FIG. 9) of the first information service data structure, i.e., a pointer to the first information service. Similarly, linkage to the first category is provided by storing in the directory structure 91A the address of the location in the device memory 58 of the first category data structure, i.e., a pointer to the first category. The directory structure 91A further include information including the total number of information services, the total number of independent information services, the total number of categories in the directory, the network identifier, and the home region identifier. The directory structure 91A is generated in memory of the messaging device in response to an OTAP message programming the messaging device to receive messages having the signaling addresses of the PSA of the directory. The directory structure stores the network and home region identifiers provided by the OTAP message, and is updated to provide links to the first information service and category structures when added to the directory profile, and to maintain the total number of categories and information services as their associated structures are added (or deleted) in the directory profile.

Each category structure 91B contains a category identifier, the category title associated with the category identifier, category status flags, total number of services directly under the category, and links to the directory structure 91A, the previous category structure, unless it is the first category, i.e., that to which the directory structure has a link, in which case this link is NULL, and to its first daughter information service. Linkage to the directory structure 91A is provided by storing in the category structure 91B the address of the location in the device memory 58 of the directory data structure, i.e., a pointer to the directory structure. Linkage to the previous category structure, if a previous category exists, is provided by storing in the category structure the address to the location in memory 58 of the previous category data structure, i.e., a pointer to the previous category structure. Linkage to the first information service under the category is provided by storing in the category structure 91B the address to the location in memory 58 of the first information service for that category, i.e., a pointer to the information service of the first information service for that category. If the category has no information services, then the link is NULL until such information services are provided under the category. Similarly, if the category structure represents the first category of the directory, the link to the previous category identifier is NULL. The category status flags include category home enable flag, category roam enable flag, and a new flag. The category home enable flag and category roam enable flags represent whether all of the services under that category are home and/or roam reception enabled, respectively. The new flag indicates whether that category has newly been added in the stored directory profile. The directory level flags may also be included in the set of category status flags to indicate the level in the directory of the category. For example, if the directory profile stored a directory as shown in FIG. 2A, CATEGORIES A, B, and C are at level one, and SUBCATEGORIES A, B, and C are at level two. A subcategory below a category is represented by a category structure 91B having a link to its previous parent category in which its directory level is indicated by its category identifier and/or by directory level flags. The data representing the total number of services directly under the category is updated as information service structures are added or removed which are linked directly under the category.

Each information service structure 91C contains the information service address, information service title associated with the information service address, service status flags, an advertising type flag, and advertising text, and has links to the directory structure, its parent category, unless it is at the base level of the directory in which case this link is NULL, the previous information service, unless it is the first information service, i.e., that to which the directory structure has a link, in which case this link is NULL, and to the next information service in the list. Linkage to the directory structure is provided by storing in the information service structure 91C the address of the location in device memory 58 of the directory data structure, i.e., a pointer to the directory structure. Linkage to the parent category is provided by storing the address of the location in device memory 58 of the parent category data structure, i.e., a pointer to the parent category of the information service, in the information service structure 91C, unless no parent category exists. Linkage to the previous information service is provided by storing the address of the location in device memory 58 of the previous information service data structure, i.e., a pointer to the previous information service, in the information service structure 91C, unless it is the first information service. Linkage to the next information service is provided by storing the address of the location in device memory 58 of the next information service data structure, i.e., a pointer to the next information service, unless it is the last information service. The service status flags include a home enable flag and a roam enable flag to indicate if the information service is home and/or roam enabled or disabled, one or more temporary folder flags indicating the desired folder in memory of the messaging device where storage of messages for the information service are to be stored, and a new flag which is set when the information structure is first added to the directory profile. Thus, the information services, when stored as a directory profile in memory of the messaging devices, are stored in a linked list of information service data structures, which are each linked to the directory structure, and further linked to category structure under a category, subcategory, or no category.

When a define service or define category directory message is processed, new entries (information service or category structures, respectively) in the linked list are added to the existing linked list entries. Through previously applied key sequences via the user interface of the messaging device, or by default, desired information service addresses may have already been home and/or roam enabled for decoding on the device by setting either or both of the home and roam enable/disable flags among the information service status flags to enable decoding and storage of corresponding service messages, and the display representation of the directory in accordance with the directory profile reflects this, as will be described below in reference to FIGS. 10A-10B.

Optionally, independent information services can be entered by a user in the directory profile rather than from define service directory messages. Independent information services may use the ASCII numerical equivalent of their variable length title for their service address. When the user enters an independent information service with data representing an information service address and associated title, a manually entered independent information service structure 91D is generated in the link list. Independent information services are entered at the base level of the directory, and hence are not related to any category. Each independent information service structure 91D includes, the information service address, the title associated with the information service address, status flags, and links to the next and previous independent information service structures and to the directory. Links to the next and previous independent information service structures are provided by storing the addresses of the locations in device memory 58 of the next and previous independent information service data structures in the independent information service structure 91D. The first directory message independent service structure's link to the previous service is set to NULL and the last directory message independent service structure's link to the next service is set to NULL. The directory structure 91A further includes the total number of independent services in the directory profile and a link to the first independent information service (i.e., by storing the address of the location in device memory 58 of the associated information service data structure), if one exists, else to NULL. The total number of independent information services is updated in the directory structure 91A as independent information service structures are added or removed from the directory profile.

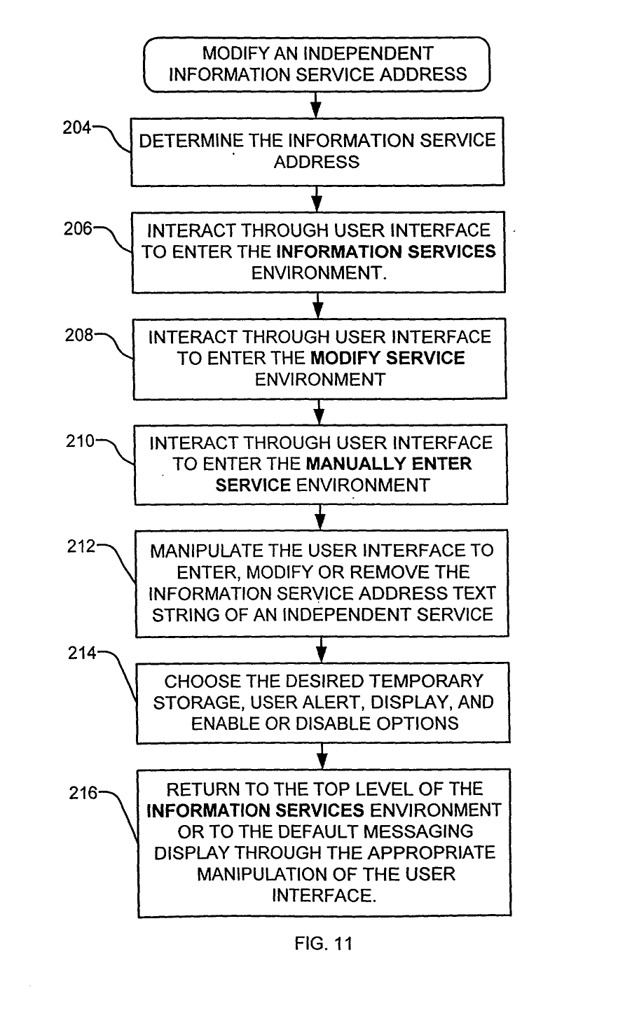

As will be described below in connection with FIGS. 7A-7G, structures 91B and 91C are added, removed, or updated in the linked list of the stored directory profile in each of the messaging devices 24 in response to directory messages. While, structures 91D are added, removed, or updated in the linked list of the stored directory profile in each of the messaging devices 24 in response to each user's manual entry, removal, or modifying, of the title providing the address of independent information service, as described later in connection with FIG. 11.

An example of a directory profile is shown in FIGS. 8, and 8A-8B. FIG. 8 shows a directory organized in three levels having two categories CAT A and CAT B, two subcategories SUB CAT A and SUB CAT B, seven information services SERV 1-7, generated by directory messages, and two independent information services IND SERV 1-2. FIGS. 8A-8B shows a directory profile having the types of structures of FIGS. 6A-6D which may be stored in a messaging device corresponding to the directory organized in FIG. 8. Each column from left to right represents the list of category structures, list of information services structures (generated by directory messages), and list of independent information service structures. The list of category structures and information services (generated by directory messages) structures continues from FIG. 8A to FIG. 8B. Other directory organizations and corresponding directory profile may be provided in accordance with the directory messages and any independent information services entered by the user of a messaging device 24. For purposes of illustration, the order and level of the categories and subcategories is indicated by the category identifiers, and the order of addresses for information services generated by directory messages. Other identifiers and addresses may be used as the links of structures to record the order of the structures in the directory profile. Preferably, the address of the category identifiers includes a second character indicating the level of the category. However, such level may be maintained by the category status flags of the category structures. In the case where no categorical organization is provided in directory messages received, the directory profile would appear similar to that shown in FIG. 2B where all services are at the base level and are linked to each other. For example, if no categorical organization were present in the directory profile of FIGS. 8A-8B, the category (and subcategory) structures would be absent, the links to category (and subcategory) structures would be absent in the information service structures (generated by directory messages) and independent information service structures, and the total number of categories stored in the directory structure would not be necessary.

The reception and processing by messaging devices 24 of each directory message of steps 84 and 86 of FIG. 5 is shown in FIGS. 7A-7G for the example of an alphanumeric pager 24a. The directory message is received by messaging devices 24 the same way that any message is received by an RF receiver 54 (FIG. 4), except that the directory reception should be transparent to the user and serve as an automatic update. In other words, the directory message is processed automatically without the user of the messaging device being aware that a directory message was received and then stored in an updated directory profile. The process of identifying the signaling address, signature flag, and directory flag of a directory message received by a messaging device are illustrated at steps 234-246 of FIG. 14A, which generally describes the process in the messaging devices 24 for receiving messages. In FIG. 7A, the controller 52 (FIG. 4) provides these operations through a message identifier 92 which processes the decoded message to the extent necessary to determine: 1) whether the signaling addresses matches one of the radio signaling address, e.g., a PSA, stored in memory that the device will decode upon reception, 2) the next character after the protocol fields is associated with a signature flag which identifies the message as being from an information service provider, and 3) the next character, which if the message is a directory message, represents a directory flag set to a character associated with one of the types of the directory messages. If the directory flag is not set, the message is an information service message if the signature flag is set, or a typical page message if the signature flag is not set. Further decoding of a directory message identified as a directory message by the message identifier 92 is provided by the directory message interpreter/decoder 94 of the controller 52 in accordance with the encoded data structure of FIGS. 3A-3D.

The directory message interpreter/decoder 94 has the next two characters decoded to obtain the network and region identifiers, and checks whether the message network identifier matches the network identifier stored in the messaging device memory and the region identifier of the message matches the home region identifier stored in the messaging device. The network and region identifiers may be stored in the directory structure 91A (FIG. 6A). If so, the directory message interpreter/decoder 94 decodes the remainder to the message in accordance with the encoded data structure for the particular type of directory message FIGS. 3A-3D as indicated by the received directory flag, and provides the information as input data to the directory message processor 96, and its component processors 96A-96D. Depending on the type of the directory message, the directory message is processed by one of processors 96A, 96B, 96C, and 96D. The operation of processors 96A, 96B, 96C, and 96D, are described in FIGS. 7B, 7C, 7D, and 7E, respectively.

Although alphanumeric characters are used in encoding and decoding directory messages, the directory message interpreter/decoder 94 may be programmed for identifying converted alphanumeric symbols of the directory message into typical numeric representation for storage and processing, such as binary or hexadecimal or other, if needed.

When the directory message is received, the directory profile will either be in an initial state of a default directory, or a prior version of the directory provided from a previously received set of directory messages. The category identifiers, if supported, and information service addresses of the directory messages are used to update the on-device directory profile through either define service/category messages or remove service/category messages. The one-to-one mapping of categories to identifiers and services to addressees is defined in the directory profile. The messaging device automatically updates the directory profile upon reception of a directory message by installing or deleting the service structure or category structure (if supported) in the linked list which defines the directory profile shown in FIGS. 6A-6C.

Referring to FIG. 7B, if the message is a define service message, then the service address, category identifier, title of information service, advertising type, and advertising text are all decoded as input to define service processor 96A (step 104). The define service processor loops through the directory profile comparing the information service address in the message with those in each information service structure (step 106). If the service address matches one already stored in the device directory profile (step 108), then that information service structure is retained and reprocessed (step 110). The user settings associated with the service are not changed. The category identifier is overwritten with the new (possibly different) category identifier, the title of the information service is overwritten with the new (possibly different) title, the advertising type is replaced with the new (possibly different) advertising type, and the new advertising text is replaced with the new (possibly different) advertising text. If the service address does not match one already stored in the device directory profile (step 108), then at step 112 a new information service structure is created, the service address, category identifier, information service title, advertising type, and advertising text are installed in the new information service structure, the user settable parameters associated with the service are cleared and the flag indicating a new service is set. If a new information service structure is created at step 112, the controller 52 adds one to the stored total of the number of information service generated from directory messages in the directory structure 91A to reflect the new total number of information services generated from directory messages. If a new information service structure was added directly under a category or subcategory, one is added to the data representing the number of services for that category in the category or subcategory structure, respectively. Having so processed the define service message, the entire directory is reprocessed by the directory post processor 98 of FIGS. 7F-7G to install or correct links in the directory profile due to the modification or addition of the information service structure.

Referring to FIG. 7C, if the message is a remove service message, then the information service address is decoded as input to the remove service processor 96B (step 114). The remove service processor loops through the directory profile comparing the information service address in the message with those in each information service structure (step 116). If an information service structure associated with the information service address in the remove service message resides in the directory (step 118), then the structure in the directory that holds the information, settings, title, are all deleted (step 120), otherwise the message is discard (step 122). The controller 52 subtracts one from the stored total of the number of information service generated from directory messages in the directory structure 91A to reflect the new total number of information services generated from directory messages. Also, if the information structure removed was directly under a category or subcategory, one is subtracted from the data representing the number of services for that category in the category or subcategory structure, respectively. Having so processed the remove service message, the entire directory is reprocessed by the directory post processor 98 of FIGS. 7F-7G to install or correct links in the directory profile provide if an information service structure was removed.

Referring to FIG. 7D, if the message is a define category message and categorical organization of the directory is not supported by the device (step 124), then the message is ignored (step 125). Alternatively, if the device supports categorical organization, then the category identifier and category title are decoded as input to the define category processor 96C (step 126). The define category processor loops through the device directory comparing the category identifier in the message with those in each category structure (step 128). If the category identifier matches one already present by the directory (step 130), then the settings associated with the category are retained and the category title is overwritten with the new (possibly different) category title (step 132). If the category identifier does not match one already employed by the directory (step 130), then a new category structure is created and the category identifier and category title are installed in the new category structure (step 134). To complete the creation of a category or subcategory, the information services that should be organized directly below it are so organized and referenced by virtue of the parent category indicator included in the service structure (FIG. 6C), that was provided in the define service message that originally supplied the service to the directory. Having assembled the services of the category or subcategory, the category status flags can be set: whether or not any of its services are home and/or roam enabled (step 135). If a new category structure is created at step 134, the controller adds one to the stored total of the number of categories in the directory structure 91A to reflect the new total number of categories. Having so processed the define category message, the entire directory is reprocessed by the directory post processor 98 of FIGS. 7F-7G to install or correct links in the directory profile provide due to the modification or addition of a category structure.

Referring to FIG. 7E, if the message is a remove category message and categorical organization of the directory is not supported by the device (step 136), then the message is ignored (step 137). Otherwise, the category identifier is decoded as input to the remove category processor 96D (step 138). If a category structure associated with the category identifier in the remove category message resides in the directory, i.e., the message's category identifier 46F (FIG. 3D) matches a category identifier of a category structure in the directory profile (step 142), then the structure in the directory that holds the information, settings, and text, are all deleted (step 144), otherwise the message is discarded (step 146). The controller 52 subtracts one from the stored total of the number of categories in the directory structure 91A to reflect the new total number of categories. Having so processed the remove category message, the entire directory is reprocessed by the directory post processor 98 of FIGS. 7F-7G to install or correct links in the directory profile if a category structure was removed.

Referring to FIGS. 7F and 7G, the operation of the directory post processor 98 is shown for maintaining the links necessary for integrity of the linked list. Such linkage was described earlier in connection with FIGS. 6A-6D, and shown for example in FIGS. 8A-8B. The directory structure 91A and interlinked lists of category structures 91B and information service structure 91C represent the input for the post processor (step 148). If a directory element, i.e., category structure or information service structure, was added to the directory profile (step 150), the appropriate location in the linked list is determined. The appropriate location in the linked list for the added category or information service structure is then determined (step 152). For a category structure, the category structure is added to the last category with same parent category, and if none exist, the last category in the base level of the directory profile. For an information service structure, the information structure is added to the last information service having the same parent category, and if no parent category exists, the information structure is added to the last information service in the base level of the directory profile. Next, the new structures links are added by setting the new structure's previous element link to the structure preceding it in the list, and then setting the new structure's next element link to the structure following it in the list (step 154). If when added to the list, the element represents the last element of the same type of structure, then its next element link is set to NULL. The neighbor structure's links to the new structure are then added by setting the previous structure's next element link to the new structure, and setting the next structure's previous element link to the new structure.

If a directory element, i.e., category structure or information service structure, was removed from the directory profile (step 150), the links are appropriately set for structures that were the previous link and the next link of the removed structure from the list (step 158). In other words, the previous structure's next element link is set to the next element in the link after removal of the structure, and similarly, the next structure's previous element link is set to the previous element in the link after removal of the structure. If the removed element was an information service structure, a check is made to assure that the removed service's parent category daughter list was not the first information service under that category (step 160). If so, the category structure is set to the next information service structure which followed the removed information service structure, and if no information service structure followed, the link in the parent category to the first information service is set to a NULL value.

After step 156 or 160, or if an element in the directory was only updated at step 150, then at step 162 the post directory processor 98 loops through each service structure in the directory profile. For each information service structure, the post directory processor loops through each category structure to identify if the category structure has a category identifier that matches the category identifier stored in the information service structure (steps 164-165). If so, the information service structure sets the parent category link to that of the category identifier (step 166). If the information service is the first information service for that category, then the category structure's daughter information service link is updated to that of the information service address of the information service (step 168). If the category is that last category in the linked list (step 170), then all the category structures have been checked for that information service, and then next information service structure is processed through steps 164-170. After the last service structure has been processed (step 172), the post processing is completed (step 174).

Thus, the directory post processor 98 loops through the category structures of the directory to install and/or correct links to and from the new category and its parent category, if it is a subcategory, and any other links in need of modification due to the addition. Also, the post processor loops through the service structures to install and/or correct links to and from the new category structure and the other service structures in the directory. If the messaging device does not supports categorical organization, only the service structures are processed by the directory post processor, and steps 162-172 are not required.

When a service structure is removed, the directory post processor 98 loops through the category structures of the directory to install and/or correct links that had pointed from the parent category, if the service had a parent category, to the service just removed. In any case, the post processor loops through the service structures to remove and/or correct links that had pointed to the removed service structure and the other service structures in the directory.

When a category structure is removed, the directory post processor 98 loops through the category structures of the directory to install and/or correct links that had pointed from the parent category to the category just removed and then loops through the service structures to remove and/or correct links that had pointed to the removed category structure and the other service structures in the directory.

Referring back to FIG. 7A, after a directory message is processed by the directory message post processor 98, the controller delete the directory message from its memory and the directory profile on the messaging device is fully and transparently updated (step 100). Henceforth, when the user modifies the directory profile, such as by disabling a service or category of services, or home and/or roam enabling, or modifying the display, alert, and temporary storage attributes that a given information service is to be associated with, it will be through interaction with one or more intermediary updated directories as directory messages are continuously received and processed.

Generally, the directory profile can be composed in a variety of different forms provided that it is consistent with a well-defined protocol that is compatible with both the transmission protocol into which the directory protocol must be encoded and the decoding ability of all types of messaging devices used in the system. For example, encoding an entire directory with or without a rich categorical organization structure into a single large message may be provided. This may be inconsistent with the resources of a simple alphanumeric pager, however, implementation of this invention on a broadband transmission system with devices, like handheld computers, that could easily handle directory messages with greater complexity. The directory messages are encoded into displayable ASCII characters, but they may be encoded in any type of data field, such as bit fields, hexadecimal encoded fields, encrypted fields, or other encoding methods depending on the capability of the messaging device to decode such data fields. Further, other types of data could be included in directory messages, such as graphical images and sound, instead of, or in addition, to text in the directory.

Information service addresses that are not provided to the directory profile by directory messages can be added to the messaging device's stored directory profile through user input, via the user interface of the device, to add an independent information service structure. These independent information services can then be home and/or roam enabled or disabled the same way as information services associated with the directory profile. The titles/service addresses of these directory message independent information services may be determined by the user, for example, through advertisements either by the system provider or by a sponsor of the information service. Independent information service addresses can also be added to the stored directory profile by entering them on a PC and loading to the device through some type of data interface such as an infrared port or bus. Additionally, a user may enter independent information service addresses through interaction with a provider, for example, on an interactive web page with the provider then loading the address to the device profile through transmission of an OTAP message.

Referring to FIG. 9, an example of the user interface 59 (FIG. 4) for messaging devices 24 is shown for paging units 24a. Other types of user interfaces may be used which enable a user of a messaging device to view the stored directory profile and interact therewith, such as scrolling and selecting items through one or more screens, to home and/or roam enable or disable decoding of information services under categories. Since scrolling and cursor control are typical features on messaging devices capable of receiving page messages, implementation of directory perusal and service choice may be provided by messaging device software modifications. User interface 59 includes display screen 60, such as a LCD display, and multiple keys (or push buttons) 62A-62F.

As stated earlier, each of the information services has a set of service status flags in their respective information service structure 91C in the directory profile stored in messaging devices 24, including home enable flag, roam enable flag, temporary file flag(s), and new flag. When the home and/or roam enable flags are set for an information service, then the messaging device is programmed to fully decode the desired information service message in the home region, if home enabled, and/or in another region, if roam enabled. How the device responds to reception of an information service message is dictated by the temporary storage folder to which it is assigned in accordance with temporary folder flags associated with the information service in the directory profile. For example, information service messages assigned to information service folder 1 may be automatically displayed and generate an audible alert notifying the user that a message has been received, while information service messages assigned to information service folder 2 may not be automatically displayed and may generate, for example, a vibrational alert. Setting the response attributes for a reception folder may be similar to that of conventional paging units. Thus, the user is alerted of reception of information service messages and the messages are displayed according to the attributes of the temporary folder flags associated with the information service.

A flow chart showing the process of modifying information service reception through interaction with the stored directory profile, via user interface 59, is shown in FIGS. 10A and 10B. This process is enabled by displaying and navigating through a series of screens representing category and information service titles organized in the order defined by the linked list of the directory profile, where the user can set desired options through these screens. Upon entering each screen, the cursor will be set on some option by default; the position of the cursor can be indicated by the given option flashing on and off, by the option appearing in reverse video, by an actual cursor, such as an arrow, or other typical cursor position identifying means. The position of the cursor through listed items may be changed by the user pressing the right or left scroll keys 62D-E, or other keys on the user interface providing similar function. To access the information service options, a user presses the select key 62F repeatedly until “information services,” is displayed, and then presses the select key 62F to enter the information service environment (step 176). An example of this screen is shown in FIG. 9A. To enter the directory for the purpose of modifying service reception, the user then presses the scroll right and scroll left keys 62D and 62E to set the cursor on the “modify service” option and presses the select key 62F to enter the modify service environment (step 178). An example of this screen is shown in FIG. 9B. The modify service environment allows the user to view the directory in accordance with the directory profile stored in the messaging device. Having entered the “modify service” option, the directory is displayed with the base level categories and/or information services displayed in the sense of a directory. A base level is first displayed as the root level of the directory. For example, in directory profile of FIGS. 8A-8B the base level would include the titles of categories CAT A and CAT B, and SERV 6 and SERV 7 from their respective structures. Information service listings at the base level are accessed by the controller 52 from the linked list of information service structures of the directory profile with null pointers (links) to previous category, and information service structure with NULL parent category links. Category titles at the base level are accessed by the controller 52 from the category structures of the directory profile with null pointers (links) to their parent addresses. Just the base level may be displayed, or the greater directory can be displayed, e.g., categories may be displayed with their daughter information services and with their daughter subcategories, and subcategories may be displayed with their daughter information services, if the messaging device display supports several lines of display. As many categories and information services can be displayed as the device display can support. The user can scroll down or up the screen with scroll keys 62D-E, if the size of screen 60 cannot display the full base level. In every case, subcategories are accessed by the controller 52 from the category structures of the directory profile with non-null pointers (links) to their previous category, and information services associated with categories or services are accessed by the controller 52 from the service structures of the directory profile with non-null pointers (links) to their parent category. The scroll left and scroll right keys 62D-E are used to position the cursor on a category or service. To descend a level in the directory, the user navigates the cursor to a category title and presses the select key 62f to display the daughter subcategory and/or information service listings of that category. For example of the directory profile of FIGS. 8A-8B, the screen of FIG. 9D shows the selection of CAT B from the screen of FIG. 9C to display SUB CAT A and SUB CAT B. This process can be continued—using the scroll keys to position the cursor on a category, and the select key 62F to enter that category, i.e., descend a level in the directory—for as many levels as the directory is organized. The process of the user navigating through the displayed directory using the scroll and select keys to particular information services is described at steps 180, 182 and 184, until the cursor is positioned on the title of an information service when the select key 62F is pressed to branch to step 186. When the cursor is positioned on an information service, if it is home and/or roam enabled (or disabled) as indicated by its home and roam enable flags, respectively, in the associated information service structure, this is indicated by the presence of one or more icons or accompanying indicative text adjacent the title of the information service, such as shown for example in FIG. 9G with icons 102. In FIG. 9G, a plane indicates roam enable and a house indicated home enable for the information service, but other icons or text may be used. If the home or roam enabled flags are set, icons or accompany indicative text may also be provided indicating the folder messages for the service will be stored in accordance with its temporary folder flags. Again in the example, of FIG. 9G, the icon of a folder with a one indicates storage of message for the information will be in temporary folder one, but other icon or text may be used. In this manner the user can review the current reception status of each information service to select which, if any, the user wished to update. Similarly, when the cursor is positioned on category titles, such icons or text may be provided indicating whether all of its service there under are home and/or roam enabled (or disabled) as indicated by its home and roam enable flags in its associated category structure. Further, an icon, illustrated for example as a paper scroll in the screens of FIGS. 9A-9G, may optionally be provided in screens of the information services environment for reminding the user that they are in this environment.

When a new information service is displayed on a messaging device, i.e., the first time it is displayed, it can be displayed in such a way as to draw the user's attention to the fact that it has not been displayed before, e.g., with a ‘new’ icon or accompanied by special characters or in a different font or other similar display notification means. The controller 52 recognizes a new information service by virtue of it having a set new flag among its status flags in the stored directory profile. The first time an information service is displayed, the new flag is cleared. Similarly, a category will also have a new indication if its new flag is set when its title is displayed, and after the user select the category to view the information service (or subcategories) under the category, the new flag of the category is cleared. Similarly, subcategories may have a new indication if its new flag is set when its title is displayed, and the new flag cleared when its information service (or further subcategories) under the subcategory are displayed.

The displayed directory allows the user to review the enable/disable status of information services and to modify certain service status flags associated with information services in the stored directory profile. To enable or disable reception of an information service or to modify its alert/display/storage attributes, the user sets the cursor on the desired information service title. With a cursor positioned on an information service and its home and/or roam enabled or disabled icons or accompanying indicative text displayed, the reception properties of the information service can be modified by pressing the select key 62F to illuminate (display) three options: ‘enable,’ ‘enable options,’ and ‘disable’ (step 186). The cursor points by default to ‘disable’ if the information service is currently home and/or roam enabled (i.e., its home and/or roam enable flags are set), or to ‘enable’ if is currently disabled (i.e., its home and roam enable flags are not set). An example of the screen following selection of an information service is shown in FIG. 9F for Serv 4 of the screen in FIG. 9E. The options are chosen by navigating the cursor to that desired with the scroll keys 62D and 62E (step 188). With the cursor set to ‘enable,’ pressing the select key causes the controller 52 to set both the home and roam enable flags (step 190), and, if the service has not already been associated with a temporary storage folder, then it is assigned ‘Info-folder 1’ by default in the set of information service status flags; the display then returns to the information service title with the home and roam enable icons or accompanying indicative text. With the cursor set to ‘enable options,’ pressing the select key 62F displays two or more options for assigning the alert, display, and temporary storage attributes for the information service (step 192). The alert and display attributes of information service message reception are assigned in reference to the temporary storage folder: ‘info-folder 1’ or ‘info-folder 2’ which are displayed as two option (step 194). The user selects one of the options using the scroll key to move the cursor to the desired option and select key 62F to select the option. For example, if a single temporary folder flag is used for each information service, the flag when set indicates folder 2, and when not set indicates folder 1. However, other status flags may be provided to indicate other types of alert in addition to, or instead of the folder flags, to set the type of desired user alert. Upon selecting a folder, the controller 52 sets the appropriate folder flags in the set of information service flags; the display then presents three options: ‘home enable,’ ‘roam enable’, and ‘disable’ (step 196). The cursor points by default to ‘disable’ if the service is currently home and/or roam enabled (i.e., its home or roam enable flags are not set), or to ‘enable’ if is currently disabled (i.e., its home and roam enable flags are not set). The options are chosen by navigating the cursor to that desired by pressing the scroll keys 62D-62E (step 198). With the cursor set to ‘home enable,’ pressing the select key 62F causes the controller 52 to set the home enable flag for that information service (step 202); with the cursor set to ‘roam enable,’ pressing the select key 62F causes the controller to clear the home enable flag for that information service (step 200); with the cursor set to ‘disable,’ pressing the select key causes the controller to clear both the home and roam enable flags for that information service (step 191). Similarly, if ‘disable’ was earlier chosen at step 188, then both the home and roam enable flags are cleared among the set of service status flags (step 191). Having so configured the reception attributes, and enabling or disabling the information service, the display returns to the information service title with the home, roam enable and folder icons or accompanying indicative text also shown. The scroll right key 62D can be used to jump forward to the next category, while the scroll left key 62E can be used to jump backward to the previous category. To cease directory profile manipulation and return the device to its default display, the main key 62A is pressed. Default display refers to the basic screen on the messaging device for typical page message receiving.

The manual entry, removal, or modification of independent information services, i.e., information services that are not provided to the messaging device by directory messages, through interaction with the user interface 59 (FIG. 9) is described in the flow chart of FIG. 11. The user may be made aware of an independent information service and its related information service address from one of different sources, such as the service provider or from advertisements (step 204). The address of an independent information service is identical to its title which can be composed, by one word or a concatenated set of words, but in general could include spaces, such that the use are readily determine the address of the independent information service. The address, therefore, may be variable length. To access the information service options, the user presses the scroll keys repeatedly until the cursor is set on “information services” in the device's display and then presses the select key 62F (step 206), such as earlier described at step 176. Then a user presses the scroll keys 62D-62E to set the cursor on “modify services” and presses the select key (step 208), such as earlier described at step 178. Next, the user presses the scroll keys to set the cursor on “manually entered services” on the menu shown, and presses the select key 62F (step 210). “Manually entered services” appears to the user as a list of services parallel to the directory. For example, in the screen of FIG. 9B, “manually entered services” would appear below “modify services” Serv 7 as the user scrolled down using the scroll key 62E. Next, the manually entered service display screen is shown with an enumerated list of previously entered independent information service addresses/titles, if any, and at the end of the list an empty enumerated slot is displayed where independent information service addresses/titles can be entered. For example, in the directory profile of FIGS. 8, 8A-8B, the title/addresses of independent information services 1 and 2 from their respective structures would be listed on the manually entered service display screen. The user can enter, modify or remove an information service address text string of an independent information service by updating this list (step 212), and choosing the desired temporary storage/user alert attributes, and enable or disable options (step 214). If the independent information service list has reached its full capacity, then no such empty slot is displayed; in this case, another address cannot be added to the list, though any of the entries in the list can be edited. To navigate to an element of the list or to an empty slot, a user presses the scroll right and scroll left keys 62D-62E to set the cursor on the desired element or slot. When the cursor is set to an element in the list, in addition to the service address/title, the display includes the appropriate enable or disable and folder icons or accompanying indicative text, as described earlier for an information service generated from directory messages, in accordance with the status flags of the independent information service. Pressing the select key 62F illuminates (displays) the following options: ‘enable’, if enabled (i.e., if its the enable flag is set), otherwise ‘disable’ (i.e., its enabled flag is not set); ‘change service’; and ‘delete service’. A user presses the scroll right and scroll left keys 62D-E to set the cursor on the desired option and presses the select key 62F to either exercise that option or bring up any associated options. Exercising the disable option causes the controller 52 to clear the enable flag for that independent information service. Exercising the enable option causes the controller 52 to set the enable flag for that independent information service, and displays the options ‘info-folder 1’ and ‘info-folder 2.’ As for information service generated by directory messages, the alert and display attributes are assigned in reference to the temporary storage folder flags. Upon selecting a folder, the controller 52 sets the appropriate folder flags in the set of information service status flags. If the ‘change service’ option is chosen, then the cursor appears on the first character of the information service address/title, pressing the left and right scroll key 62D-E causes the given character in the display to change to the next or previous character in the sequence of characters: a-b-c-d-e-f-g-h-i-j-k-l-m-n-o-p-q-r-s-t-u-v-w-x-y-z-0-1-2-3-4-5-6-7-8-9-_-delete, the last character of this sequence appear as a blank space, pressing the left scroll key 62D then puts the letter ‘a’ in that space and the sequence continues. When the desired character is displayed, pressing the select key 62F inserts the given character into the currently selected character position and the cursor is advanced to the next character position. If the delete character (space) was displayed and the select key 62F pressed, then whatever character had been in that position is deleted and the character to the right, if there is one, is shifted to the left. When the service address/title has been set as desired, pressing the select key and holding it down for longer than a full second causes the independent service address/title to be written to that slot by the controller 52 and the options: ‘enable’ (if enabled, otherwise ‘disable’), ‘change service’, and ‘delete service’ are all displayed and the process continues as described above. Additionally, a user may enter independent information service address(es) to the stored directory profile by entering them on a PC (personal computer or other computer-based system) and loading to the messaging device through an interface, such as an infrared port, serial data interface, or connectable data bus, or through interaction with the provider, for example on a web page with the independent service address loaded on the device through an OTAP message transmitted by the service provider. Writing of the independent information service address/title to a slot which was previously filled, updates the address/title stored in the structure associated with the independent information service in the directory profile. If the cursor is navigated to an empty slot and the select key 62F is pressed, then the messaging device enters the ‘change service’ state described above, but with the cursor on a single ‘a’, this character is modified and the service address/title is completed and a new independent information service structure 62D (FIG. 6D) is created in the directory profile. The new independent information service structure is added to the end of the list of independent information service structure and has its links so accordingly set. If the delete service option is chosen, then the service address/title and all data associated with it are deleted from the independent information service list by the controller 52 and the display points to this empty slot with possible interactions as described above. The independent information service structure associated with deleted structure is removed from the directory profile, and its links to the previous independent information service structure, if present, and next independent information service structure, if present, are accordingly modified to maintain the linked list.

In any case, after an independent service is added, changed, or deleted, the display returns to the independent information service list with the cursor set to the just modified element address/title, including the appropriate enable or disable and folder icons or accompanying indicative text (step 216). When the enable flags in the set of service status flags for independent information services are set, then the messaging device is programmed to fully decode the information service messages for that independent information service upon receipt. The user is alerted of reception of the independent service message and the message is displayed according to the attributes of the temporary folder storage flags assignment. Optionally, the independent information service may be similarly provided with home and roam enable flags, and folder flags, which may be set using the enable options screens similar to that described at steps 192-202 of FIG. 10B.

Optionally, global enabling or disabling of all information services under a category (and under subcategories for that category) may be provided to avoid the need for the user to manually enable each information service under a category. This may be provided by holding down the select key 62f on a displayed category title down for longer than a full second to provide a display of options to: home enable, roam enable, home and roam enable, or disable, all information services for the category. The scroll keys position the cursor on the desired option, and pressing the select key select that option. Selecting home enable, sets all home enable flags for such information service. Selection of roam enable, sets all roam enable flags for such information service. Selecting home and roam, sets all roam and home enable flags for such information services. Selecting disable, clears all home and roam enable flags for such information services. When the user enables all information service under a category, the folder flags default to folder 1. When a home and/or roam enable flags for information services are all set under a category, the home and/or roam enable flags in its associated category structure are set. Conversely, if any home and/or roam enable flags for information services are not set, or are cleared by the user, the home and/or roam enable flags in its associated category structure are cleared if set.

In general, directory navigation and parameter setting can be defined on any type of alphanumeric messaging device using similar key sequences, or with other types of user interfaces, for example, it is straightforward to define methods for directory profile manipulation with devices such as a mouse, stylus, touchscreen, trackball, trackpad, keyboard, a microphone for voice input, or other similar devices. Further, directories can be displayed in many different ways: with icons, folders, or other graphical and textual indicators. Again, the description of the system using an alphanumeric messaging device serves to demonstrate how the invention can be applied in this environment. Messaging devices with greater processing power, larger display screens, and user interfaces with better cursor control may be similarly provided, for example, manual entry of service address/titles could most straightforwardly be entered on a device with a keyboard. Options can be expressed as text or other display items using graphics, e.g., icons and, of course, the implementation of this invention may employ default cursor positions other than those described herein.

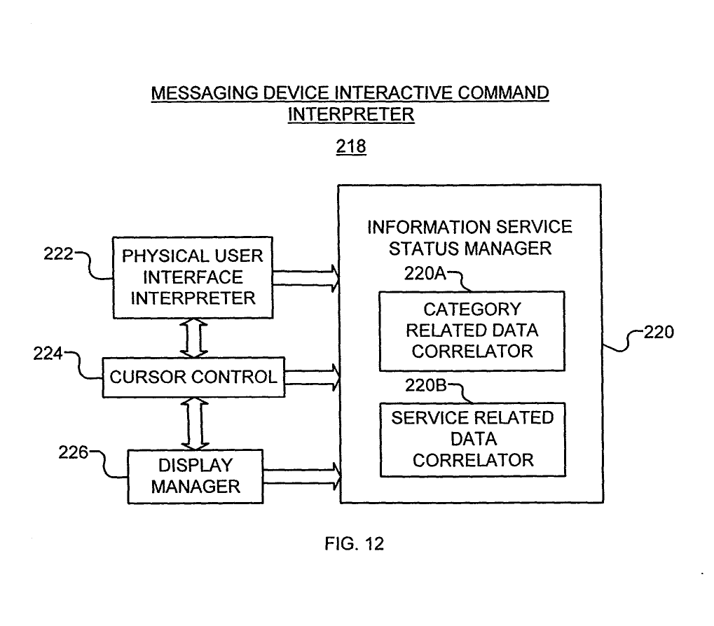

Referring to FIG. 12, a software messaging service interactive command interpreter 218 for interpretation of key sequences by the user navigating through the directory profile is shown. The controller 52 of the messaging device 24 operates in accordance with such software. The interactive command interpreter 218 has an information service status manager module 220 which operates in response to a physical user interface interpreter 222, to provide which of keys 62b-62e are pressed, and a cursor controller 224 to provide the item on a screen near the position of the cursor. For example, the physical user interface interpreter is a key sequence interpreter, but in general represents an interpreter for any possible physical interface, e.g., mouse, stylus, touchscreen, trackball, trackpad, keyboard, a microphone for voice input, or other similar devices. The display manager 226 is used by the module 220 to highlight the status of the directory and its elements being viewed on a display, e.g., whether or not the directory has recently been updated, the status of information services, such as whether a service is home and/or roam enabled, disabled, or new, the status of categories, such as whether a daughter service is enabled, if the category is new, as described earlier. Such highlighting can include graphical display, such as icons, accompanying text, reverse video, differentiating character font, indicative of the status of a service or category, as described earlier. The module 220 operates based on the screen outputted for a directory profile, and updates the screen as keys 62b-62e are pressed and positions the cursor where the scroll keys dictate. Module 220 has a category correlator 220A which stores the one-to-one correspondence of displayed category titles to category identifiers, and status flags, and an information service correlator 220B which stores the one-to-one correspondence of displayed information service titles to information service addresses, status flags, advertising type, and advertising text. When a key sequence dictates that the status flags of a service or category are modified, the correlator software 220A or 220B tends to the modification in the directory profile and the display manager 226 sets the display accordingly.

The operation of the software of the messaging devices 24 in response to received information service messages having the PSA of the directory, or a set signature flag with another radio signaling address the device has been programmed to receive, will now be described. Upon reception of an information service message the first several characters of the message are decoded to reveal the network identifier, the region identifier, and the information service address. First the network identifier is decoded to indicate the network that transmitted the message. If the network of origin does not match the network identifier internally programmed on the device then the message is discarded. If the network identifier does match, then the region identifier is decoded to indicate the region from which the message was transmitted. Next, the information service address is decoded. The device is programmed to survey all information service structures stored in its directory profile. If it does not find the structure associated with the information service address, then the message is ignored, if it does find a match, then the messaging device determines whether or not the information service is disabled or home and/or roam enabled. If the information service is disabled, then the message is ignored. If the region identifier of the message matches the home region of the device and the information service is home enabled, then the message is fully decoded, stored, otherwise if the region identifier of the message does not match the home region of the device and the information service is roam enabled, then the message is fully decoded and stored. When the message is fully decoded, it is stored in the temporary storage folder in accordance with temporary folder flags associated with the information service. How, or if, the user is alerted upon receipt of an enabled message is dictated by the folder with which the message is associated. If the information service has advertisement content associated with it in the information service structure, then that content is included with the message as prescribed by the advertisement type flag whenever the message is displayed.

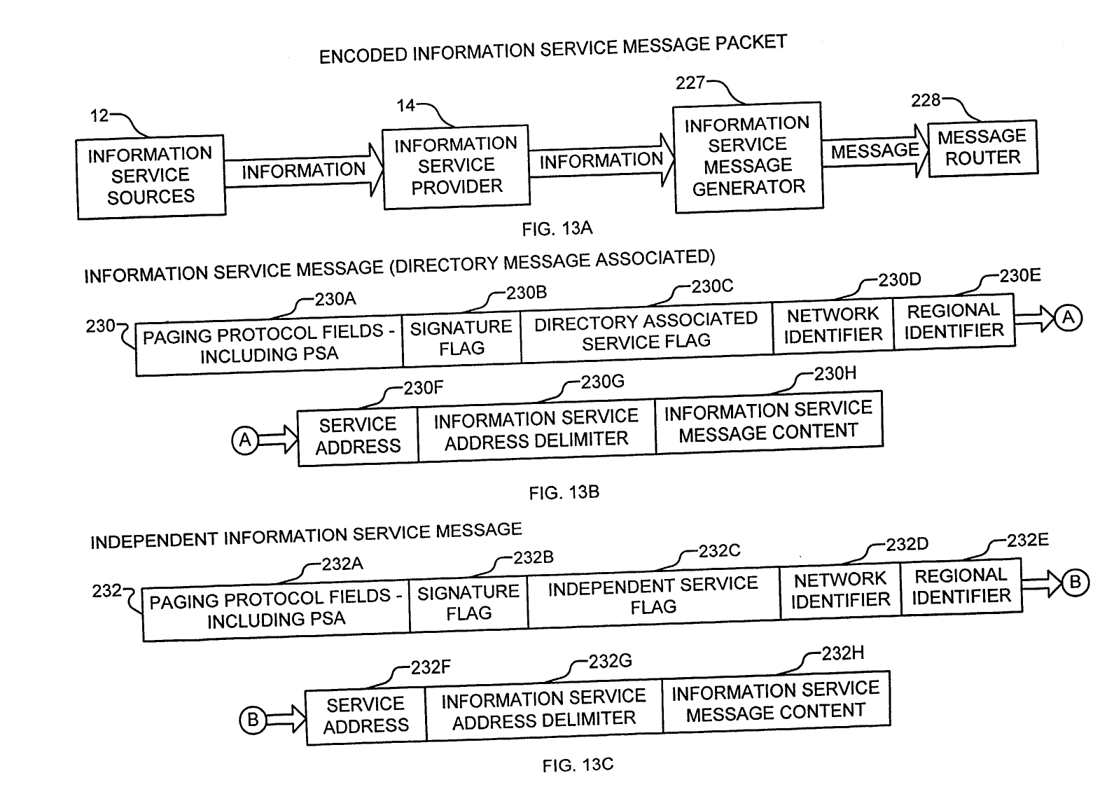

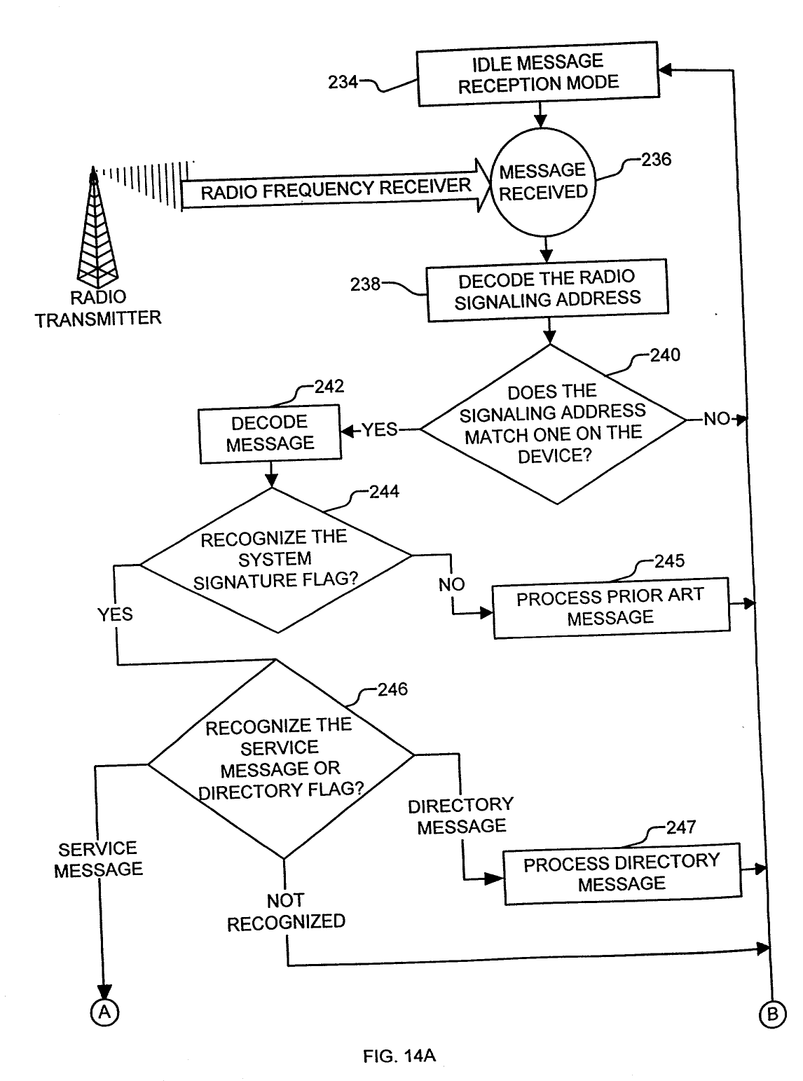

The construction, transmission, reception, and decoding of information service messages in system 10 are shown in FIGS. 13A, 13B, 13C, 14A and 14B. Information service messages are assembled in packets for transmission as shown in FIG. 13A. Information is provided by an information source 12 with a designated topic to the computer service of service provider 14, which has information service generator software 227 to encode the information received into a transmittable form that includes the appropriate network identifier, region identifier, and information service address appropriate for the topic of the information received. The topic of the information from source 12 have been previously associated to an information service (and corresponding information service address) when the directory was first established at steps 32 and 34 of FIG. 3, or the topic of the information from source 12 is associated with an independent information service (i.e., independent information service title/address) designated in the computer system of the service provider 14.

The data structure of each information service message 230 for information services associated with directory messages provided to messaging devices 24 encoded by information service generator 227 is shown in FIG. 13B. In this example, the information service message 230 is formatted in displayable ASCII strings at step 144 such that the message can be processed into a wireless message transmittable to messaging devices 24 by the message router 228, which may be the same message router as described earlier at step 38 in FIG. 3. After the paging protocol fields 230A, which may be the same as paging protocol fields 40A, 42A, 44A, and 46A of directory messages (FIGS. 3A-3D) having the PSA, message 230 includes a signature flag 230B which is a single character, e.g., “]”, as in a directory message, indicating that the message is related to the information service system. The service message flag 230C is a single character indicating that the message is an information service message generated by a directory message, e.g., “ˆ ”, rather than an independent information service message or a directory message. The network identifier 230D is encoded in the next character of the message. The region identifier 230E is encoded in the following two characters, and the information service address 230F is encoded in the subsequent two characters representing the information service address of the information service related to the message content being sent. An information service address delimiter character 230G, e.g., “]”, follows the address 230F. The character 230G is primarily useful when the service address 230F represents an independent information service address message, but in message 230 provides a visible separator of the addressing information and the information service message content. The information service message content 230H follows the delimiter 230G, contains the information received from the source 12, and is composed of 7 bit alphanumeric characters encoded using the standard (ISO 646-1983E) ASCII character set used by the FLEX Protocol, or other wireless messaging protocol used by system 10. The size of field 230H depends on the message content.

The data structure of an independent information service message is the same as that of information service message 230, except that the independent service flag 232C is used with a variable length service address 232F. In other words, the data structure of an independent information service message 232 has fields 232A, 232B, 232D, 232E, and 232G are similar to fields 230A, 230B, 230D, 230E, and 230G respectively. Independent service flag 232C represents a single character indicating that the message is an independent information service message, e.g., “&”. Since the service address 232F of an independent information service can have an arbitrary number of characters for an information service message associated with a manually entered title/address by users, the information address delimiter 232G serves the purpose of indicating the conclusion of an information service address 232F and provides a separator of the addressing information and the information service message content 232H. The size of field 232H depends on the message content.

In either case of information service message 230 or 232, each information service message may be referred to as having a unique address, whether the two characters encoded address or the arbitrary length of the independent information service address/title. The information service message 230 or 232 is then encoded using standard wireless messaging technology in accordance with a transmission protocol compatible with the transmission system represented by 16, 18, 20, and 22 (FIG. 1) by message router 228 (FIG. 13A) and then sent by one or more transmission systems in modulated radio frequency transmissions to messaging devices 24 in coverage areas associated with geographic regions of the transmission systems to messaging devices 24, as shown in FIG. 1. Such transmission is the same as described earlier in connection with transmission of directory messages.

Addressing formats for information service messages 230 for information services associated with directory messages may optionally incorporate category and subcategory identifiers under which the information service is organized in the directory, or use the information service title as the information service address, as in independent information services.

Referring to FIGS. 14A and 14B, the process for receiving and identifying information service messages 230 or 232 at the messaging devices 24 is shown. The controller 52 (FIG. 4) of the messaging device first waits in an idle message reception mode (step 234) until a message is received (step 236). The controller 52 using the message decoder 56 (FIG. 4) decodes the information service message to the extent necessary to decode the radio signaling address (step 238), and then checks if the radio signaling address matches those in the list of signaling addresses stored in memory that the device will decode upon reception (step 240). If so, the controller 52 decodes the message to the extent necessary to reveal the signature field (step 242), otherwise the controller returns to the idle message reception mode at step 234. If the first character is the signature flag (step 244), then it continues decoding the information service system message to the extent necessary to reveal the next character, otherwise it decodes and processes the non-information service system message (step 245) and the controller returns to step 234 to wait for the next message to be received. A non-information service message may represent a typical message received by a conventional messaging device, such as a pager, and processing of non-information service messages by controller 52 may be typical to that of a conventional messaging device to decode, store and/or alert a user. The next character in the message is then decoded. If the next character following the signature flag is one of the service message flags, indicative of either an associated with a information service associated with a directory message, e.g., “ˆ ”, or an independent information service, e.g., “&”, then the controller 52 recognizes the information service message and branches to step 248. If the next character following the signature flag is associated with one of the directory messages, then it is so processed (step 247) as described earlier in connection with FIGS. 7A-7G, and the device returns to the idle message reception mode at step 234. If the next character following the signature flag is not among the information service system flags or one of the directory flags, then the message is ignored, and the controller 52 returns to the idle message reception mode at step 234.

The third character is then decoded to obtain the message's network identifier, which is then compared with the network identifier programmed in the messaging device (step 248). If the two are not the same, then the message is ignored, and the controller 52 returns to the idle message reception mode at step 234. If the two are the same, then the message was transmitted by the network with which the messaging device 24 is associated. The region identifier is then decoded from the next two characters of the message and then stored for later processing (step 249). The information service address is then decoded (step 250). In particular, if the service message flag indicated that it is an information message associated with a directory message, then the information service address is decoded from the following two characters and the information service address delimiter, e.g., “]”, is decoded and discarded. However, if the service message flag indicates that it is an independent service message, then the information service address is decoded from the following characters until the information service address delimiter, e.g., “]”, is decoded. The messaging device controller 52 then searches through the list of information service structures (associated with directory messages) 91C and independent information services 91D, depending on the service message flag, in the directory profile comparing the decoded service address with those in the list (step 251). If the decoded service address does not match one in the list, then the message is ignored, and the controller 52 returns to the idle message reception mode at step 234. If it does match a service address in the list, then, through the status flags contained in the structure associated with the service address in the messaging device's memory, it is determined whether or not the service is enabled, how it is enabled, e.g., home and/or roam, and the temporary folder flag with which it is associated.

If the type of message received is an information service message 230 (step 252), as indicated by the received service flag, the controller checks whether the region identifier of the message matches that stored in the messaging device's memory, i.e., the directory structure, (step 254) and whether the information service associated with the received information service address is home enabled, i.e., its home enable flag is set (step 255). If both the region identifier matches the home identifier then the message is from the home region, and the information service is home enabled, the controller branches to step 258, otherwise the message is discarded and the branch is taken to idle message reception mode at step 234. If the region identifier does not match the home identifier of the message at step 254, the controller checks if the information service associated with the received information service address is roam enabled, i.e., its roam enabled flag is set (step 256), and if so, branches to step 258, otherwise the message is discarded and the branch is taken to idle message reception mode at step 234.

If the type of message received is an independent information service message 232 (step 252), as indicated by the received service flag, the controller checks whether the service is enabled, i.e., the enable flag is set in the independent information structure having the received information service address), and if so, branches to step 258, otherwise the message is discarded and the branch is taken to idle message reception mode at step 234. If both home and roam enable flags are used with independent information service, rather than a single enable flag, steps 254-256 are performed when the independent service message is received.

At step 258, the message content following the information address delimiter is decoded and stored in memory of the messaging device, and the user alerted, according to attributes of its folder flags associated with the information service associated with the received information service address (step 258). If the advertising option is employed for the information service, advertising text may be embedded and stored with the message so that it appears whenever the message is displayed, by preceding or following the message text according to the advertisement type flag being set or not set, respectively, in the information service structure associated with received information service addresses. Although advertising text is described herein, other information (e.g., text, graphics, or sound) not limited to advertisements may be received via directory messages and stored in the directory profile of messaging devices for attachment to stored messages. The text of the title of the information service may be stored and displayed with the information service, with other information, such as time and date of message reception.

The display on the messaging device 24 of the context of each decoded information service message stored in memory may be provided to the user the same as a typical message received on a messaging device such as a typical paging unit. If multiple messages are received, the user may choose the appropriate temporary storage folder through a top level menu of the messaging device, using the user interface, and scroll through each information service message, and may choose from delete or save options using conventional procedures for permanent storage or deletion of the message. The time and date of message reception and/or the title of the service may be provided when an information service message is displayed. If the advertising option is employed, advertising text embedded and stored with the message may also be displayed. Since the text of the title of the information service may be stored and displayed with the information service, the user is made aware of which enabled information service provided the message. In this manner, if the user no longer wishes to obtain the information service, he or she is aware of which enabled information service to select to disable. Further, if memory space allocated for message storage has been exceeded, such messages may be removed according to a well defined procedure, for example, oldest read messages in temporary storage folder 2 deleted first, followed by oldest read messages in temporary storage folder 1, followed by oldest unread messages in temporary storage folder 2, followed by oldest unread messages in temporary storage folder 1. Message in folders may also automatically removed, if they are older than predefined number of days, such as 30 days, based on the time and date of the stored message.

It is straightforward to generalize the concept of text based information service messages to include graphics, sound, or other multimedia data, by using, for example, an appropriately defined messaging protocol with an appropriate transmission protocol and well defined signifiers and decodable instructions for processing the elements of the multimedia message.

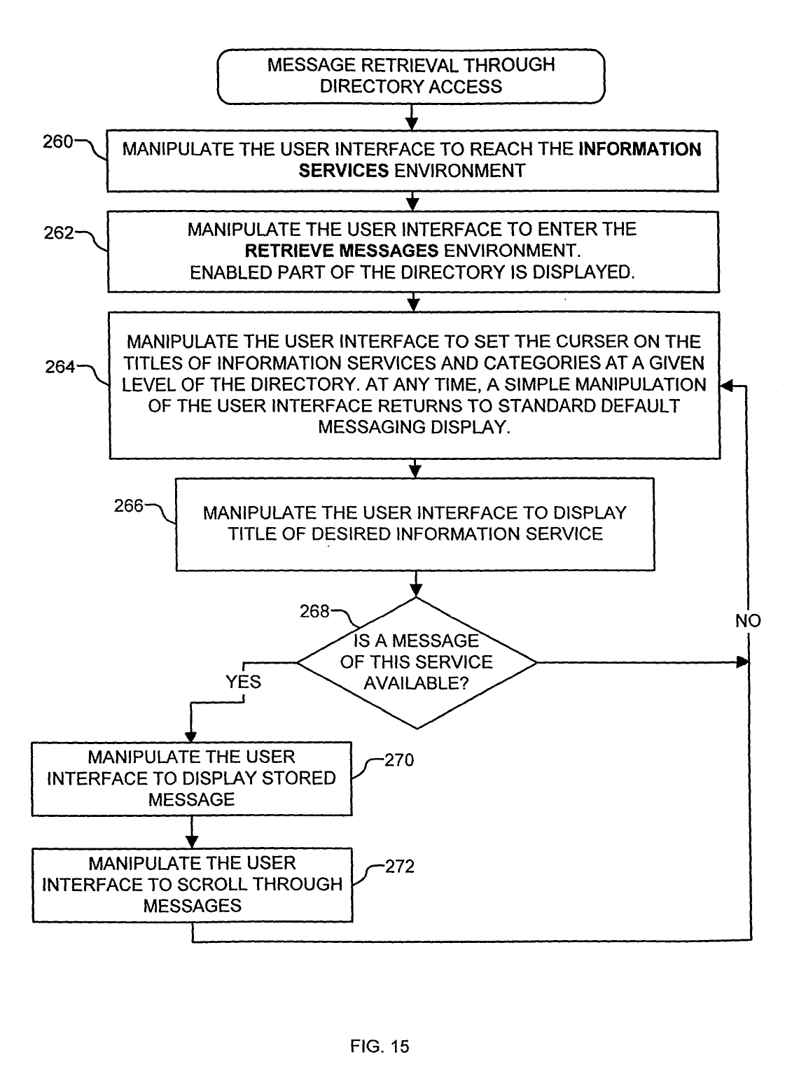

The messages may be stored in other ways to organize messages and associate their display and alert attributes. For example, messages may be organized in the same way as the directory so that the information service structures also include a pointer to associated messages, such that using the same set of screens as the directory profile described earlier in connection with FIGS. 10A-B, as shown in FIG. 15. In FIG. 15 the user enters the ‘information services’ environment just as in FIG. 10A at step 176 (step 260), presses the scroll keys 62d-e to set the cursor on a ‘check messages’ option and presses the select key 62f to enter the directory based message access menu (step 262). For example, a screen such as shown in FIG. 9B may be used. In this menu the directory is displayed the same as it is for the process of modifying service reception in FIG. 10 at steps 180, 182, and 184, but with only category titles and/or subcategory titles that have enabled information services associated with them, and only the enabled information services shown. In other words, only category (and subcategory) titles associated with category structures which have under them information services enabled (roam or home enable flags set) in the stored directory profile of the messaging device are displayed; information service titles associated with information service structure from directory messages with roam or home enable flags set are displayed; and independent information service titles associated with independent information service structures having enable flags set are displayed. As the user peruses these enabled categories and services in this retrieve messages environment by using the scroll keys 62D-E to display the title of a desired information service (steps 264 and 266). Elements are displayed with icon(s) or accompanying indicative text to indicate the presence of new and/or old messages, to inform the user whether a message for an information service is available (step 268). When the cursor is set on one of these categories or services and the select key 62f is pressed, the display shows the most recently received message (step 270), and the user may scroll through other messages, if any, associated with that service using the scroll keys 62D-E (step 272). With this storage/retrieval option, messages could include an additional data field to instruct the controller 52 whether the information service message should replace, or append to, the prior information service message having the same address, when such addresses are stored in memory with each received decoded information service message. This may be useful if the information message most recently received is the most useful, stock indices or quotes, or weather information services, for example. Further, in this option, message reception alert and display attributes may be assigned by the user through the user interface uniquely for each information service when they are enabled.

An alternative method for associating advertisement text or graphics with an information service or set of information services is to define a separate define advertisement directory message that includes the advertisement text or graphics and an advertisement identifier. Accordingly, information service structures would include an advertising identifier instead of the advertising text. Advertisement structures in their own linked list in memory of the messaging device 24 can then be associated with information services by virtue of the advertisement identifier rather than directly storing the advertisement content separately in each information service structure. This option may reduce the amount of memory required for advertisement text and or graphics when more than one information service is associated with the same advertisement.

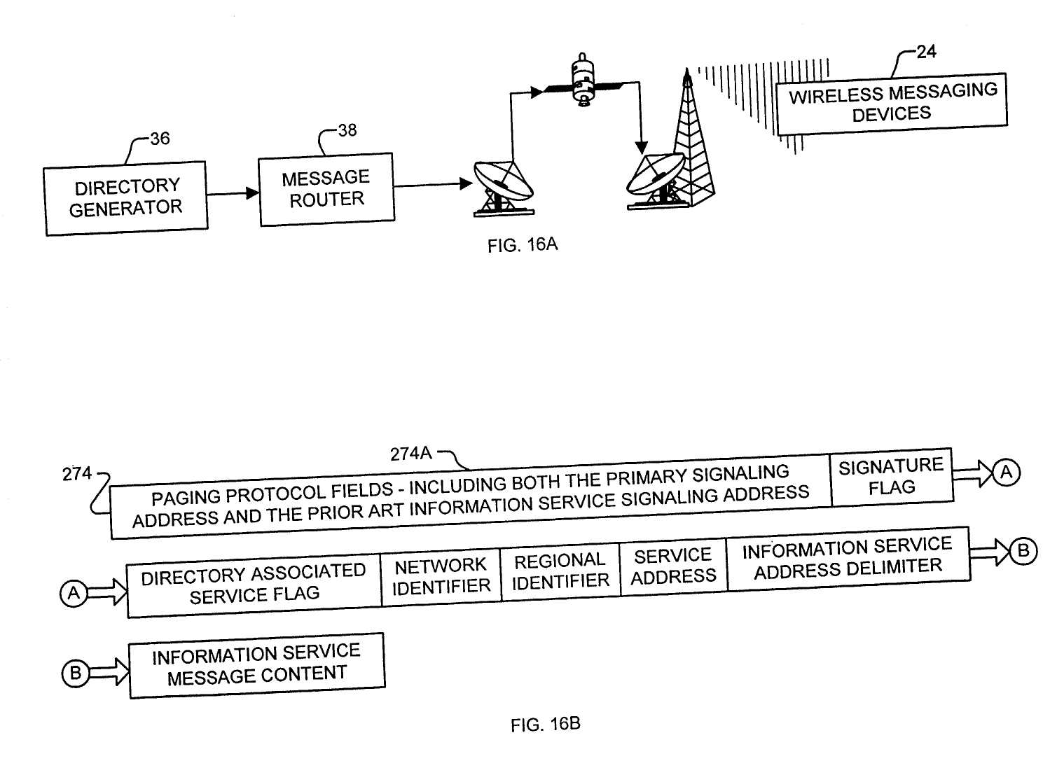

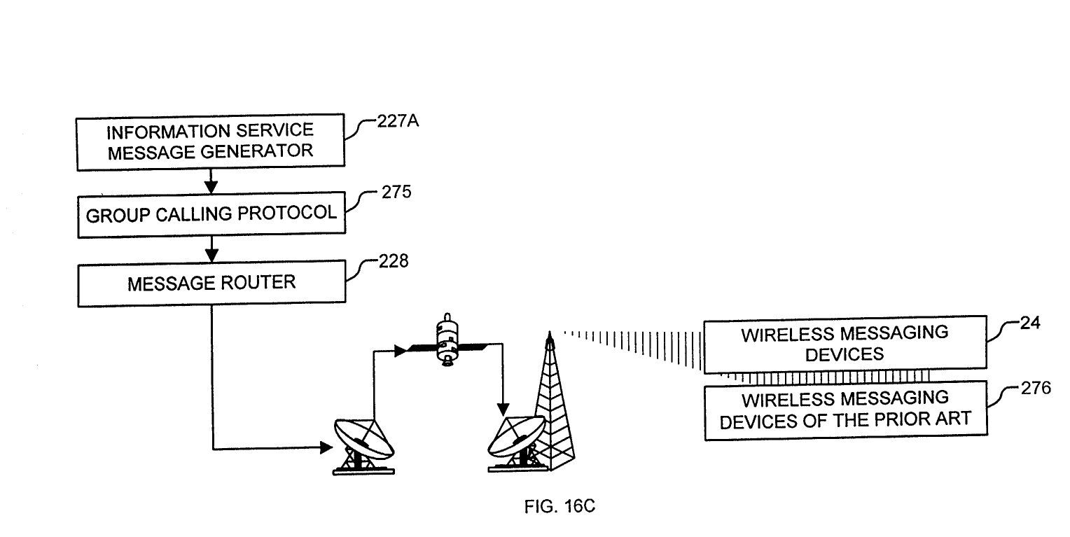

Compatibility of system 10 with prior art message delivery methods is shown in FIGS. 16A, B, and C. Backward compatibility can be achieved by the use of an existing technique such as the dynamic group calling feature of some existing industry protocols, e.g., Motorola's FLEX Protocol. The directory messages are transmitted to messaging devices 24 with a PSA, and such messages are only decoded by messaging device programmed to receive message with the PSA. Other messaging devices 24, or devices for receiving information service messages of the prior art, are not programmed with this PSA, and do not attempt to decode the directory messages. To provide backward compatibility, information service messages can be transmitted to two or more radio signaling addresses: one or more PSAs and the unique information service signaling address that embodies the prior art for sending each information service to a different unique capcode, as shown in the information service message data structure 274 of FIG. 16B. Message data structure 274 is the same as that of message 230 (FIG. 13B), but the paging protocol field 274A have in addition to the PSA the radio signaling address unique for that information service. Thus both prior art messaging devices and those in system 10 can receive and decode the same message provided by a single transmission. In FIG. 16C, the information service generator 227A operates the same as generator 227, but adds a unique information service radio signaling address to the particular information service as defined by a prior art group calling protocol 275, e.g., Motorola's FLEX protocol, to specify the unique address for each different information service. Messaging devices incompatible with system 10, indicated by 276, decode the message by virtue of the unique information service signaling address and messaging devices 24 of system 10 decode the message through the information encoded in the first few characters of the body of the message. Thus, messaging devices of the prior art continue to receive information services, though with a few nonsensical characters preceding the body of the message (i.e., signature flag character through the information address delimiter character), and messaging devices 24 in system 10 have unlimited access to information services through the updateable directory profile stored in persistent memory of the device. The delimiter character, e.g., “]”, of the message when displayed to the user may provide a visible separation between the body of the message and these nonsensical characters. In this way, backward compatibility may be achieved while minimizing the necessary bandwidth of transmission resources.

The service provider 14 may offer more than one directory of information services for delivery to messaging devices 24 in which each directory has a unique PSA. Further, a messaging device may receive one or more directories by being programmed to decode messages having the PSA of each directory. The directory profile on the messaging device can easily decode the directory messages from what the service provider may conceive of as separate directories in a unified, seamless way resulting in a single continuous directory profile on the messaging device representing multiple subscribed to directories.

One of the features of system 10 in contrast to that of the prior art is that, with system 10, a messaging device that is capable of receiving but not transmitting messages, a one-way device, can emulate the behavior of a two-way device. By providing an automatically updated on-device directory of services and allowing the user to set up reception of messages whenever convenient through interaction with the directory without the need to transmit information about these choices to the service provider, the one-way device emulates two-way performance. This permits a huge saving in cost, infrastructure, and resources both to the users of the messaging devices 24 and the service provider 14. However, the system 10 may be incorporated also in two-way messaging devices, or other wireless message receiving equipment, but without using the feedback feature of the two-way device.

Although the invention is described using regional information as included in region identifiers in messages to enable roam and home enablement of information services at messaging devices, the system 10 may operate without the roaming feature by not including the region identifier in messages, using a single enable flag for each information service structure, and not providing enablement options to users beyond selection of folder assignments.

Each of the information services may to be associated with a unique advertisement, illustrates one of the ways that information can be stored with the directory and included with messages as they are received to help reduce the demand on the transmission system by sending such advertisement in information service messages. However, the system may operate without the advertisement feature, by not including in the structure of define service directory messages 230 advertisement type and text, and thereby not requiring the storage of such information in information service structures of the directory profile or with stored received information service messages.

Thus, a system and method for wireless information service have been provided in which users of messaging device can dynamically choose specific information services through direct interaction with a messaging device without contacting or engaging the service provider and which, allows for unlimited expansion of the number of distinct information services that a messaging device has the capacity to receive and decode. A directory of information services is built by transmitting directory entries that may be categorically organized, to one or more radio signaling addresses, the PSAs. The entries are then received and decoded by all messaging devices of the system to build an on device directory profile. All information services are also transmitted to the same radio signaling address that was used for the directory message that contained their directory information. The directory of services is displayed on the messaging device through a series of screens. Users interact with the directory through pre-defined key sequences to enable and disable the reception/decoding of different information services. The key sequences flag specific software service addresses for decoding, i.e., information service address. When an information service message is received, it is first processed the same way as a prior art message; that is, if the radio signaling address matches one of those internally stored in the device, the message is fully decoded. With this invention, however, further addressing information is included in the first few data of the message body including information about the transmission network, the region of origin and a service address preceding the actual message content (text and/or graphics). This information is decoded, until either the messaging device determines that the user of the device has not set the device to receive the information service message, in which case the whole message is discarded, or the message is fully decoded, stored, displayed, and the user alerted according to instructions the user previously provided to the device through interaction with the device's user interface.

By allowing users to modify their profiles of received services on their messaging devices, the system 10 solves the largest ease-of-use issue: customers no longer must interact with providers to modify their service, and providers no longer must maintain databases that include exhaustive lists of services provided to users. Since a new directory of services can be broadcast at any time, the invention also includes an intrinsic mechanism for providers to notify users of changes in available services. Further, since multiple information messages of a directory may be sent to the same radio signaling address, but are embedded with a different information service address, the number of information services a messaging device can receive is not limited to the number of signaling addresses messaging devices are capable of decoding, as in the prior art. Furthermore, for a service provider of the prior art to enable or disable information services for a messaging device, it had to enable or disable a different signaling address for each information service. By transmitting all information services to one radio signaling addresses, the service provider can activate or deactivate information services en masse through activation or deactivation of as few as one, i.e., a single PSA.

From the foregoing description, it will be apparent that there has been provided a system and method for delivering wireless information services to messaging devices. Variations and modifications in the herein described system and method in accordance with the invention will undoubtedly suggest themselves to those skilled in the art. Accordingly, the foregoing description should be taken as illustrative and not in a limiting sense.

1. A system for delivering information services to messaging devices in messages received through radio signals from one or more transmission systems comprising:
a plurality of messaging devices having memory for storing received messages;
a computer system for sending directory messages to said messaging devices through one or more transmission systems providing a directory of information services, and sending to said messaging devices information service messages through one or more transmission systems in which each of said information service messages has information related to one of said information services of said directory;
each of said messaging devices being capable of receiving said directory messages, and storing a directory of information services in memory of the messaging device in accordance with the received directory message; and
each of said messaging devices enables the user of the messaging device to enable or disable different ones of said information services in said directory stored in memory of the messaging device, in which the received information service messages by the messaging device associated with one of the enabled information services are stored in memory of the messaging device for retrieval by the user of the messaging device.

2. The system according to claim 1 wherein said directory messages and information service messages are each sent to said messaging devices utilizing a radio signaling address, and said radio signaling address of said directory messages and information service messages are the same.

3. The system according to claim 2 wherein each of said information services has a unique data address for identifying different ones of said information services which are different from the radio signaling address used for sending directory messages and information service messages.

4. The system according to claim 2 wherein each of said messaging devices is programmed to decode messages received having at least said radio signaling address of said directory messages and information service messages.

5. The system according to claim 1 wherein one or more of said information services are organized under categories in said directory and each of said messaging devices stores the directory of information services under said categories in memory of the messaging device in accordance with received directory messages.

6. The system according to claim 1 wherein one or more of said information services organized under categories are further organized under subcategories in said directory, and each of said messaging devices stores the directory of information services under said categories in said subcategories in memory of the messaging device in accordance with received directory messages.

7. The system according to claim 1 wherein each of said messaging devices operates independent of said computer system to enable or disable different ones of said information services in said directory stored in memory of the messaging device.

8. The system according to claim 1 wherein each of said messaging devices enables a user to add one or more information services to said directory stored in memory of the messaging device independent of said directory messages received, and said computer system sends information service messages to said messaging devices for said added information services.

9. The system according to claim 1 wherein each of said messaging devices updates the directory stored in memory of the messaging device in accordance with said received directory message as each of said directory messages are received.

10. The system according to claim 9 wherein said directory messages are one of different types and each of said messaging devices updates the directory stored in memory of the messaging device in accordance with the type of each of said directory message received.

11. The system according to claim 1 wherein multiple ones of said directory are sent in directory messages to messaging devices by said computer system, and each of said messaging devices stores in said directory in memory of the messaging device in accordance with directory messages received for said multiple ones of said directory.

12. The system according to claim 1 wherein each of said directory messages and information service messages have at least a network identifier and said directory messages and information service messages having a network identifier not matching a network identifier stored in memory of the messaging device are discarded by the messaging device.

13. The system according to claim 1 wherein each of said directory messages and information service messages have at least one flag identifying the messages as being one of said directory messages and information service messages.

14. The system according to claim 1 wherein each of said messaging device is capable of operating for receipt of messages not associated with said directory.

15. The system according to claim 1 wherein each of said information service messages sent have at least a geographic region identifier associated with the region from which the information service message was transmitted.

16. The system according to claim 15 wherein at least one of said messaging devices is provided with home region identifier in memory of the messaging device, and each of said messaging devices enables the user of the messaging device to enable or disable for home region reception for different ones of said information services in said directory stored in memory of the messaging device, in which the received information service messages by the messaging device having a region identifier matching the stored home region identifier in memory of the messaging device which is associated with one of a home enabled information services are stored in memory of the messaging device for retrieval by the user of the messaging device.

17. The system according to claim 15 wherein at least one of said messaging devices is provided with home region identifier in memory of the messaging device, and each of said messaging devices enables the user of the messaging device to enable or disable for roam in regions other than said home region for different ones of said information services in said directory stored in memory of the messaging device, in which the received information service messages by the messaging device having a region identifier not matching the stored home region identifier in memory of the messaging device which is associated with one of a roam enabled information services are stored in memory of the messaging device for retrieval by the user of the messaging device.

18. The system according to claim 1 wherein one or more of said information service messages stored in the messaging device have attachment information provided from memory of the messaging device in accordance with received directory messages.

19. The system according to claim 18 wherein said attachment information represents an advertisement for display with information service messages when retrieved by the user.

20. The system according to claim 1 wherein each of said messaging devices has a user interface enabling the user to view said directory of information services stored in the messaging device, and to modify which of said information service are enabled or disabled.

21. The system according to claim 1 wherein each of said messaging devices enables the user of the messaging device to select one of a plurality of folders for storage in memory of the device of at least the information provided by received information service messages.

22. The system according to claim 1 wherein each of said messaging devices represent one of paging units, handheld computers, or wireless telephones.

23. The system according to claim 1 wherein one or more of said messaging devices are one-way messaging unit capable of only receiving messages.

24. The system according to claim 1 wherein each of said messaging devices further comprises means for displaying retrieved stored messages.

25. A method for delivering information services through radio signals to messaging devices having memory for storage of messages received comprising the steps of:
sending directory messages to said messaging devices providing a directory of information services;
sending to said messaging devices information service messages having information associated with said information services of said directory;
receiving at each of said messaging device said directory messages and storing a directory of information services in memory of the messaging device in accordance with the received directory message;
selecting at each of said messaging devices by the user of the messaging device which of said different ones of said information services are enabled or disabled; and
receiving and storing in memory of each of the messaging devices for retrieval by the user of the messaging device said information service messages associated with one of the enabled information services at the messaging device.

26. The method according to claim 25 wherein said directory messages and information service messages are each sent to said messaging devices utilizing a radio signaling address, and said radio signaling address of said directory messages and information service messages are the same.

27. The method according to claim 26 wherein each of said information services has a unique data address for identifying different ones of said information services which are different from the radio signaling address used for sending directory messages and information service messages.

28. The method according to claim 26 further comprising the step of programming each of said messaging devices to decode messages received having at least said radio signaling address of said directory messages and information service messages.

29. The method according to claim 25 wherein one or more of said information services are organized under categories in said directory and each of said messaging devices stores the directory of information services under said categories in memory of the messaging device in accordance with received directory messages.

30. The method according to claim 25 wherein one or more of said information services organized under categories are further organized under subcategories in said directory, and each of said messaging devices stores the directory of information services under said categories in said subcategories in memory of the messaging device in accordance with received directory messages.

31. The method according to claim 25 wherein each of said messaging devices enables a user to add one or more information services to said directory stored in memory of the messaging device independent of said directory messages received, and said computer system sends information service messages to said messaging devices for said added information services.

32. The method according to claim 25 further comprising the step of updating the directory stored in memory of the messaging device in accordance with said received directory message as each of said directory messages are received.

33. The method according to claim 25 further comprising the step of sending multiple ones of said directory in directory messages to messaging devices, and each of said messaging devices stores in said directory in memory of the messaging device in accordance with directory messages received for said multiple ones of said directory.

34. The method according to claim 25 wherein each of said directory messages and information service messages have at least a network identifier and said directory messages, and said method further comprising the step of discarding information service messages having a network identifier not matching a network identifier stored in memory of the messaging device.

35. The method according to claim 25 wherein each of said information service messages sent have at least a geographic region identifier associated with the region from which the information service message was transmitted.

36. The method according to claim 35 wherein at least one of said messaging devices is provided with home region identifier in memory of the messaging device, said selecting step further comprises the step of selecting by the user which of different ones of said information services are enabled or disabled for home region reception in said directory stored in memory of the messaging device, and said receiving and storing step further comprises the step of receiving information service messages by the messaging device having a region identifier which matches the stored home region identifier in memory of the messaging device associated with one of a home enabled information services for retrieval by the user of the messaging device.

37. The method according to claim 35 wherein at least one of said messaging devices is provided with home region identifier in memory of the messaging device, said selecting step further comprises the step of selecting by the user which of different ones of said information services in memory of the messaging device are enabled or disabled for roam in regions other than said home region of the messaging device, and said receiving and storing step further comprises the step of receiving information service messages by the messaging device having a region identifier not matching the stored home region identifier in memory of the messaging device associated with one of a roam enabled information services for retrieval by the user of the messaging device.

38. The method according to claim 25 wherein one or more of said information service messages stored in the messaging device have attachment information provided from memory of the messaging device in accordance with received directory messages.

39. A wireless messaging device comprising:
means for receiving one or more directory message representing a directory of information services in one or more categories;
means for storing a directory of information services in accordance with said directory message in memory of the messaging device;
means for enabling the user of the messaging device to select which of said information services of said directory are enabled or disabled; and
means for fully decoding and storing in said memory only received information service message which are associated with enabled information services.

40. The wireless messaging device according to claim 39 wherein said directory message and said information service message are sent to the paging unit at a common wireless signaling address.

41. A system for delivering information services to messaging devices in messages received through radio signals from one or more transmission systems comprising:
a plurality of messaging devices having memory for storing a directory of information services;
a computer system for sending to said messaging devices information service messages through one or more transmission systems in which each of said information service messages has information related to one of said information services of said directory; and
each of said messaging devices enables the user of the messaging device to enable or disable different ones of said information services in said directory stored in memory of the messaging device, in which the received information service messages by the messaging device associated with one of the enabled information services are stored in memory of the messaging device for retrieval by the user of the messaging device.

42. A system for sending information to wireless messaging units capable of receiving messages at one or more signaling addresses comprising:
a plurality of wireless messaging units each having memory storing a directory of information services;
means for sending messages to one or more messaging units at the same signaling address in which each of said messages comprises at least a data address associated with an information service; and
each of said messaging units further comprise means for receiving said information service messages at said signaling address in which said messaging unit is capable of fully decoding only said messages having data addresses which are enabled by the user at the messaging unit.
